(19) United States
(12) Patent Application Publication
(10) Pub. No.: US 2025/0081975 A1
(43) Pub. Date: Mar. 13, 2025

(54) PASTEURIZATION CONTROL SYSTEM

(71) Applicant: Preddio Technologies Inc., North Andover, MA (US)

(72) Inventors: Aaron T. Ganick, Boxford, MA (US); Brian Rheaume, Westford, MA (US)

(21) Appl. No.: 18/827,148

(22) Filed: Sep. 6, 2024

Related U.S. Application Data
(60) Provisional application No. 63/642,987, filed on May 6, 2024.
(60) Provisional application No. 63/581,010, filed on Sep. 7, 2023.

(51) Int. Cl. A23L 3/00; G08B 7/06

(52) U.S. Cl. CPC A23B 2/003; G08B 7/06

(57) ABSTRACT

A pasteurization control system comprising an adjustment mechanism adapted to adjust a pasteurization parameter; a sensor adapted to sense a pasteurization condition; and a controller coupled to the adjustment mechanism and the sensor. The controller is adapted to initiate the pasteurization process in accordance with a baseline setting for the pasteurization parameter and receive data indicative of the pasteurization condition from the sensor. The controller is further adapted to modify, via the adjustment mechanism, the pasteurization parameter based on a comparison between the data indicative of the pasteurization condition and an expected value for the pasteurization condition.

### CROSS-REFERENCE TO RELATED APPLICATIONS

This application claims the benefit of co-pending U.S. Provisional Patent Application No. 63/642,987, filed May 6, 2024, and co-pending U.S. Provisional Patent Application No. 63/581,010, filed Sep. 7, 2023, the entire contents of which are incorporated by reference.

### FIELD

This disclosure generally relates to a pasteurization control system. More specifically, this disclosure relates to a system for controlling pasteurization parameters in real-time based on sensor data generated during a pasteurization process.

### BACKGROUND

Pasteurization is a thermal process that involves heating food and beverages to a specific temperature for a defined period to kill or deactivate harmful microorganisms, such as bacteria, viruses, and other pathogens, without significantly altering the taste or nutritional content. In that regard, pasteurization in the food and beverage industry is extremely important. By eliminating or reducing harmful microorganisms, pasteurization prolongs the shelf life of many products, including milk, juice, and canned goods, thereby reducing spoilage and waste.

Most importantly, pasteurization is essential for public health. It helps prevent the transmission of diseases such as tuberculosis, diphtheria, and Salmonella, which can be fatal or severely debilitating, particularly for vulnerable populations like the elderly, infants, or those with compromised immune systems. Furthermore, pasteurization enables safe transportation and storage of food and beverages, especially in regions where refrigeration is not widely accessible.

Traditional pasteurization systems can be used to implement various methods of pasteurization depending on the type of food or beverage, its acidity, and other factors. A few common pasteurization methods that can be implemented using traditional pasteurization systems include, but are not limited to, high-temperature short-time (HTST) pasteurization, low-temperature long-time (LTLT) pasteurization, ultra-pasteurization, batch pasteurization, steam pasteurization, microwave pasteurization, and ultra-high temperature (UHT) pasteurization.

HTST pasteurization, which is also known as “flash pasteurization,” involves heating liquid pasteurization articles, such as milk, to temperatures between 161-167° F. (71-75° C.) for a short amount of time (e.g., 15-30 seconds). LTLT pasteurization involves heating liquid pasteurization articles, such as milk, to lower temperatures around 145° F. (62.8° C.) for longer periods of time (e.g., 30 minutes). Ultra-pasteurization is used for products that are to be stored for extended periods of time (e.g., cream and other dairy products) and involves heating the pasteurization article above 275° F. (135° C.) for a very short period, typically 2 to 5 seconds. In batch pasteurization, which is often used for artisanal and/or small-batch products, large batches of the product are heated and held at a predetermined temperature for a fixed period, then cooled. Steam pasteurization, which is mainly used for foods like canned goods or eggs, involves exposing the food to steam at high temperatures. Microwave pasteurization is an emerging technology in which microwaves are used to rapidly and uniformly heat the pasteurization article. UHT pasteurization, which is often used for sterilization to provide foods and/or drinks additional shelf life, involves heating the product to temperatures as high as 280° F. (138° C.) for 2 to 5 seconds.

In traditional pasteurization systems, predetermined models are typically used to simulate and control the pasteurization process. In this regard, pasteurization parameters, such as belt speed or spray water temperature, are adjusted based on predictions of the predetermined models, not based on real-time sensor data indicative of pasteurization conditions and/or pasteurization unit (PU) levels within the pasteurization system. At least one drawback to this approach of controlling a pasteurization process with predictions, however, is that traditional pasteurization systems frequently account for unnecessary pause times in the pasteurization process that are not warranted by real-time conditions of the pasteurization process. For example, to prevent over-pasteurization of articles, traditional pasteurization systems often implement intermediate delays and/or pauses based on predetermined model predictions during the pasteurization process regardless of the real-time conditions of the pasteurization process.

In addition, traditional pasteurization systems and methods typically implement post-pasteurization testing as a quality control measure to verify whether a pasteurization process was effective in deactivating harmful microorganisms. However, because pasteurization processes are controlled based on model predictions, and not real-time pasteurization conditions, several challenges and risks can emerge.

For example, at least one drawback to relying on post-pasteurization testing as a means of quality control is that post-pasteurization test frequently results in inaccurate quality control results. For example, if predictive models are used to guide the pasteurization process and the actual temperatures achieved during pasteurization are unknown, the post-pasteurization testing results may not accurately reflect the safety of the product and/or article that underwent pasteurization. Moreover, without real-time temperature data, there is no reliable way to confirm that the harmful microbes have been effectively killed or deactivated. In the same vein, at least another drawback to relying on post-pasteurization testing is that post-pasteurization testing frequently provides a false sense of assurance for instances in which the post-pasteurization results indicate the product is safe when in fact incomplete pasteurization may have actually occurred. This false assurance could lead to contaminated products reaching consumers, with severe public health implications, including outbreaks of foodborne illnesses. Moreover, if a batch that is not effectively pasteurized is not discovered until post-pasteurization testing, there's significant risk of the contaminated products cross-contaminating other products and/or areas in the facility thereby leading to more widespread problems.

In addition, post-pasteurization testing results in frequent waste of resources. For example, by relying on the testing of samples from a batch post-pasteurization, products that might actually be safe are often unnecessarily destructed. Moreover, if a test comes back indicating the presence of harmful microbes, the whole batch may be discarded, leading to financial losses and wastage of resources. Furthermore, besides wasting resources, post-pasteurization testing also wastes time thereby decreasing operation inefficiency. In this regard, post-pasteurization testing can be time-consuming and delay products from moving further in the production line or reaching the market.

As the foregoing illustrates, what is needed in the art are more effective techniques for monitoring and/or controlling pasteurization processes.

### SUMMARY

Described herein are techniques for monitoring and controlling pasteurization processes in real-time to enhance the effectiveness and reliability of the pasteurization process. With the disclosed techniques, live sensor data, including pasteurization unit (PU) levels from pasteurization articles (e.g., beverages, food, etc.) can be used to dynamically adjust parameters such as belt speed, belt direction, spray water temperature, and other relevant parameters during the pasteurization process.

When compared to the traditional systems and methods for pasteurization described above, the disclosed techniques allow for the pasteurization process to be tailored to the immediate needs of the pasteurization article rather than relying on generalized models. In that regard, the disclosed techniques provide the technical advantages of enhancing both safety and efficiency relative to traditional systems and methods of pasteurization. For example, with the disclosed techniques, increased accuracy and efficiency can be achieved by utilizing real-time PU level data during the pasteurization process. In addition, the disclosed techniques provide enhanced product safety through precise control over pasteurization conditions, reductions in energy consumption and waste by optimizing operational parameters, and improved adaptability to different beverage types and production conditions.

In one independent aspect, a pasteurization control system comprising an adjustment mechanism adapted to adjust a pasteurization parameter; a sensor adapted to sense a pasteurization condition; and a controller coupled to the adjustment mechanism and the sensor, wherein the controller is adapted to initiate a pasteurization process in accordance with a baseline setting for the pasteurization parameter, receive data indicative of the pasteurization condition from the sensor, and modify, via the adjustment mechanism, the pasteurization parameter based on a comparison between the data indicative of the pasteurization condition and an expected value for the pasteurization condition.

In another independent aspect, a method for controlling a pasteurization process comprises operating a pasteurization control device in accordance with a baseline setting; receiving, from a sensor, data indicative of a condition of the pasteurization process; comparing the data indicative of the condition of the pasteurization process to an expected value for the condition of the pasteurization process; and modifying, via an adjustment mechanism, operation of the pasteurization control device based on the comparison between the data indicative of the condition of the pasteurization process and the expected value for the condition of the pasteurization process.

In another independent aspect, a pasteurization control system comprising a sensor adapted to sense a temperature of a pasteurization article contained in a vessel; a nozzle adapted to spray heated water over the vessel that contains the pasteurization article; an adjustment mechanism adapted to change a temperature of the heated water sprayed by the nozzle; and a controller coupled to the sensor and the adjustment mechanism, wherein the controller is adapted to control, via the adjustment mechanism, a temperature of the heated water sprayed by the nozzle in accordance with a baseline setting, receive, from the sensor, data indicative of the temperature of the pasteurization article, compare the temperature of the pasteurization article to an expected temperature value, and increase, via the adjustment mechanism, the temperature of the heated water sprayed by the nozzle when the temperature of the pasteurization article is less than the expected temperature value by at least a threshold amount.

Other aspects will become apparent by consideration of the detailed description and accompanying drawings.

### BRIEF DESCRIPTION OF THE DRAWINGS

FIG. 1 is a block diagram of a control system for a pasteurization process, according to various embodiments.

FIG. 2 is a block diagram of an pasteurization tunnel, according to various embodiments.

FIGS. 3A-3E illustrate various arrangements for a sensor positioned within a pasteurization article, according to various embodiments.

FIG. 4 is a flow diagram of method steps for controlling a pasteurization process, according to various embodiments.

FIG. 5 is a block diagram of a pasteurization sensor assembly, according to various embodiments.

FIG. 6 illustrates an example in which the pasteurization sensor assembly of FIG. 5 is inserted in a first vessel filled with a pasteurization article, according to various embodiments.

FIG. 7 illustrates an example in which the pasteurization sensor assembly of FIG. 5 is inserted in a second vessel filled with a pasteurization article, according to various embodiments.

FIG. 8 illustrates a cross-section view of the pasteurization sensor assembly of FIG. 5, according to various embodiments.

FIG. 9 illustrates a cross-section view of a front side of the pasteurization sensor assembly of FIG. 5 in which a temperature insulator is shown, according to various embodiments

FIG. 10 illustrates a cross-section view of a back side of the pasteurization sensor assembly of FIG. 5, according to various embodiments

FIG. 11 illustrates a side view of the exterior of the pasteurization sensor assembly of FIG. 5, according to various embodiments.

FIG. 12 illustrates a cross-section view in which a sensor insertion mechanism is installed on a vessel containing a pasteurization article, according to various embodiments.

FIG. 13 illustrates a cross-section view in which the pasteurization sensor assembly of FIG. 5 is inserted in a vessel via the sensor insertion mechanism of FIG. 12, according to various embodiments.

FIG. 14A illustrates a side view in which the pasteurization sensor assembly of

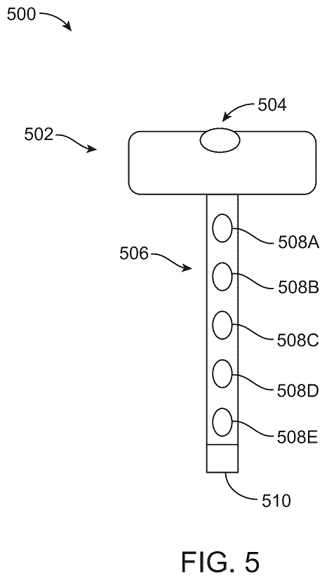

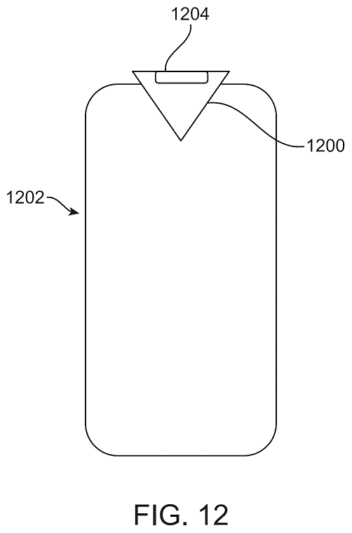

FIG. 5 is inserted in a vessel via the sensor insertion mechanism of FIG. 12, according to various embodiments.

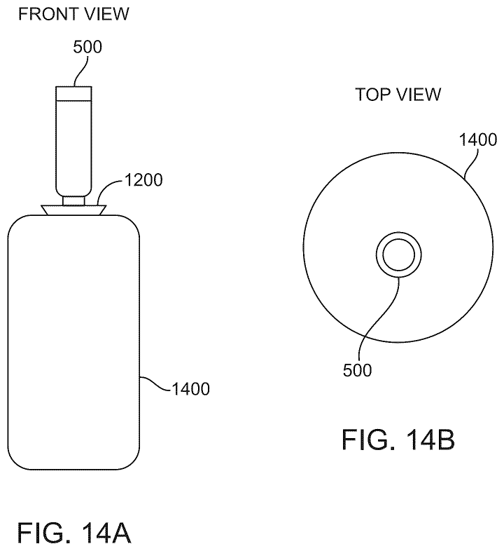

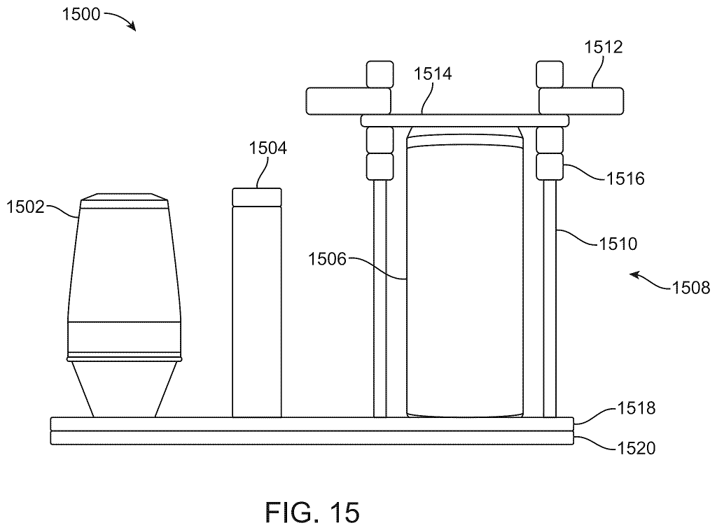

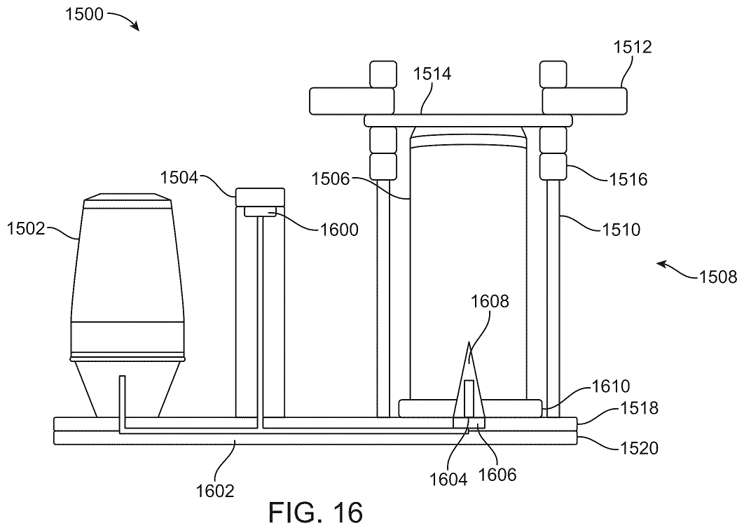

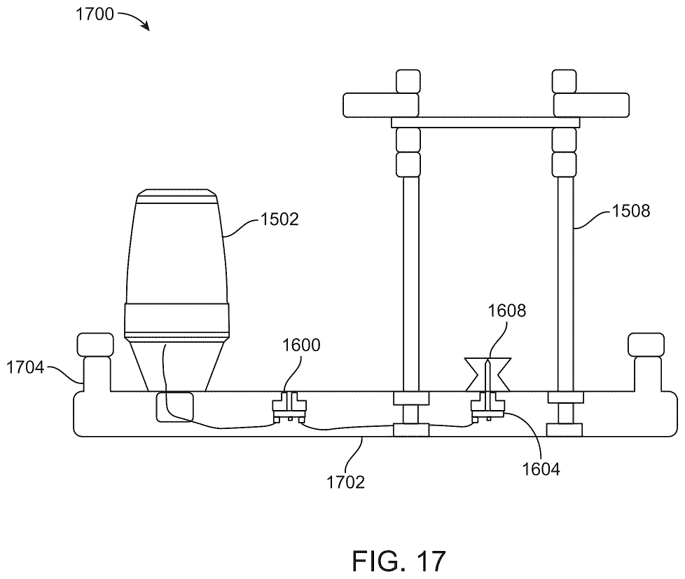

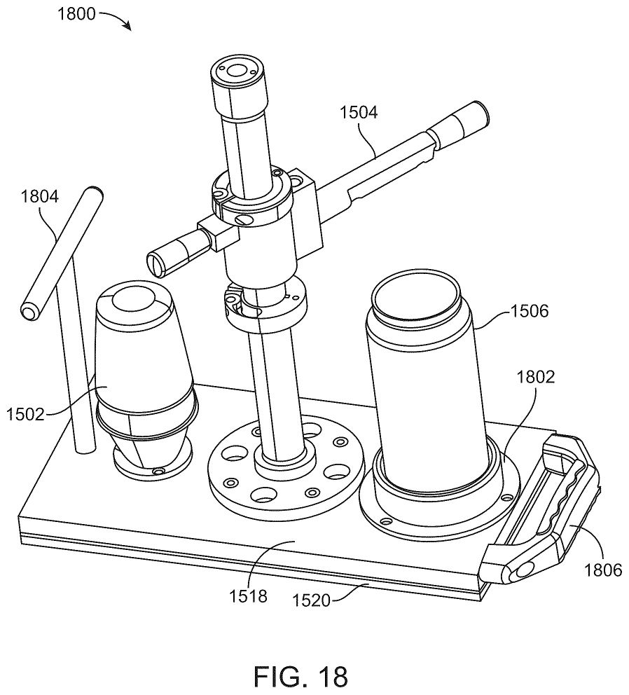

FIG. 14B illustrates a top-down view in which the pasteurization sensor assembly of FIG. 5 is inserted in a vessel via the sensor insertion mechanism of FIG. 12, according to various embodiments.

FIG. 15 illustrates a pasteurization system, according to various embodiments.

FIG. 16 illustrates a cross-section view of the pasteurization system of FIG. 15, according to various embodiments.

FIG. 17 illustrates a pasteurization system, according to various other embodiments.

FIG. 18 illustrates a pasteurization system, according to various other embodiments.

### DETAILED DESCRIPTION

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more electronic processors, such as a microprocessor and/or application specific integrated circuits (“ASICs”). As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more electronic processors, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4.” The relative terminology may refer to plus or minus a percentage (e.g., 1%, 5%, 10%, or more) of an indicated value.

Functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not explicitly listed.

### Pasteurization Control System

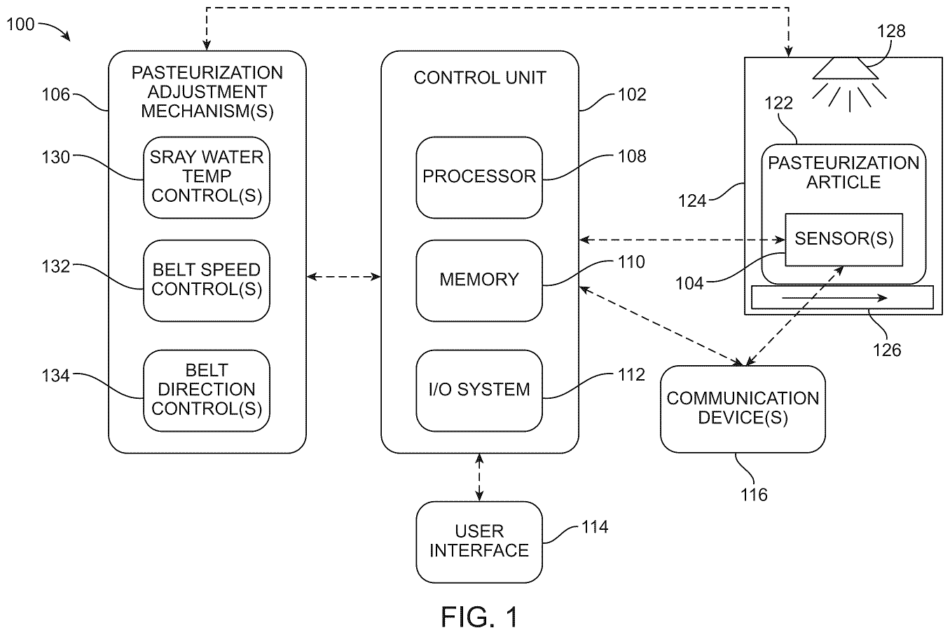

FIG. 1 is a block diagram of a control system 100 for a pasteurization process, according to various embodiments. As shown, the control system 100 includes a central controller, or control unit 102, that is communicatively coupled to one or more pasteurization sensors 104 and one or more pasteurization adjustment mechanisms 106. As will be described in more detail herein, the control unit 102 can use the one or more of the pasteurization adjustment mechanisms 106 to control parameters of the pasteurization process based on pasteurization data (e.g., temperature measurements, pressure measurements, etc.) that is generated by the one or more pasteurization sensors 104. The pasteurization data generated by the one or more pasteurization sensors 104 is indicative of real-time conditions of the pasteurization process. In that regard, the control unit 102 can use the one or more pasteurization adjustment mechanisms 106 to control parameters of the pasteurization process based on real-time conditions of the pasteurization process. Parameters of a pasteurization process can include, without limitation, spray water temperature, belt speed, or belt direction.

The control unit 102, which can be implemented as any suitable computing device (e.g., desktop computer, laptop, server, smartphone, tablet, etc.) and/or cloud-based computing device, includes a processor 108, a memory 110, an input/output (“I/O”) system 112, and a user interface 114 that are interconnected by a bus. The I/O system 112 includes routines for transferring information between components within the control unit 102 and other components of the control system 100. For example, the I/O system 112 includes a communication interface that is configured to provide communication between the control unit 102 and the one or more pasteurization sensors 104. As another example, the communication interface of the I/O system 112 provides communication between the control unit 102 and the one or more adjustment mechanisms 106. In some examples, the communication interface of the I/O system 112 communicates with the one or more pasteurization sensors 104 and/or the one or more pasteurization adjustment mechanisms 106 via one or more intermediary communication devices 116. The one or more intermediary communication devices 116 can include, for example, one or more network hubs, repeaters, bridges, switches, routers, gateways, and/or other network-connected computing devices.

The communication interface of the I/O system 112 enables the control unit 102 to communicate with the one or more pasteurization sensors 104, the one or more pasteurization adjustment mechanisms 106, and/or the one or more intermediary communication devices 116 through a wireless connection. The wireless connection can be enabled via a network, for example, a wide area network (WAN) (e.g., the Internet, a TCP/IP based network, a cellular network, such as, for example, a Global System for Mobile Communications [GSM] network, a General Packet Radio Services [GPRS] network, a Code Division Multiple Access [CDMA] network, an Evolution-Data Optimized [EV-DO] network, an Enhanced Data Rates for GSM Evolution [EDGE] network, a 3 GSM network, a 4GSM network, a Digital Enhanced Cordless Telecommunications [DECT] network, a Digital AMPS [IS-136/TDMA] network, or an Integrated Digital Enhanced Network [iDEN] network, etc.). In other examples, the network is, for example, a local area network (LAN), a neighborhood area network (NAN), a home area network (HAN), or personal area network (PAN) employing any of a variety of communications protocols, such as Wi-Fi, Bluetooth, ZigBee, etc. In some examples, the network includes one or more of a wide area network (WAN), a local area network (LAN), a neighborhood area network (NAN), a home area network (HAN), or personal area network (PAN).

The memory 110 includes, for example, a read-only memory (“ROM”), a random access memory (“RAM”), an electrically erasable programmable read-only memory (“EEPROM”), a flash memory, a hard disk, an SD card, or another suitable magnetic, optical, physical, or electronic memory device. The memory 110 stores software, such as but not limited to firmware, one or more applications, program data, one or more program modules, and/or other executable instructions, for controlling one or more parameters of a pasteurization process based on real-time conditions of the pasteurization process. For example, the memory 110 can store software that includes one or more algorithms, methods, and/or instructions for adjusting, via one or more pasteurization adjustment mechanisms 106, one or more parameters (e.g., belt speed, belt direction, spray water temperature, etc.) of a pasteurization process based on data (e.g., temperature measurements, pressure measurements, etc.) generated by one or more of the pasteurization sensors 104.

In some examples, the memory 110 further stores data that can be used for controlling one or more parameters of a pasteurization process based on real-time conditions of the pasteurization process. This data can include, for example, optimal, or expected, values for (e.g., expected temperatures, expected pressures, expected times, or expected pasteurization unit (PU) values) for particular pasteurization articles such as, but not limited to, particular beverages, particular foods, and/or other products. For example, the data can include expected temperatures and/or pressures for milk during pasteurization, expected temperatures and/or pressures for canned soft drinks during pasteurization, expected temperatures and/or pressures for dairy products during pasteurization, and/or others. The expected values for one or more pasteurization articles can be stored in memory 110 in the form of one or more tables, threshold values, and/or other data structures. In some examples, the data stored in memory 110 can further include one or more baseline settings of pasteurization parameters (e.g., spray water temperature, belt speed, or belt direction) for particular articles of pasteurization. The baseline settings for pasteurization parameters can be used by the control unit 102 to initiate a pasteurization process.

In operation, the processor 108 retrieves from the memory 110 and executes software instructions and/or data for controlling a pasteurization process based on real-time conditions of the pasteurization process. For example, in operation, the processor 108 retrieves from memory 110 and executes, among other things, software instructions associated with the processes and methods described herein for controlling, via one or more pasteurization adjustment mechanisms 106, a pasteurization process based on real-time data generated by one or more pasteurization sensors 104 and/or based on data stored in memory 110. Hereinafter, functions and/or actions performed by components of the control unit 102 (e.g., processor 108, memory 110, and I/O system 112) can collectively be referred to as being performed by the control unit 102.

As further shown in FIG. 1, one or more pasteurization sensors 104 are disposed within a pasteurization article 120 contained in a vessel 122, such as a bottle or a can. As used herein, the term pasteurization article refers to a beverage, food, or other consumer product that is subjected to one or more of the pasteurization systems, process, and methods described herein. While disposed within a pasteurization article 120, a pasteurization sensor 104 can sense and generate data indicative of one or more real-time conditions of the pasteurization article 120 during the pasteurization process. For example, a pasteurization sensor 104 can generate data (e.g., measurements) indicative of the temperature, the pressure, the position, and/or the pasteurization units (Pus) of the pasteurization article 120. Moreover, the pasteurization sensor 104 can transmit the generated data to the control unit 102 and the control unit 102 can control, via one or more pasteurization adjustment mechanisms 106, the pasteurization process based on the generated data.

In the illustrated example of FIG. 1, a pasteurization tunnel 124 that includes a conveyor belt 126 and one or more spray heads 128 is used to implement the pasteurization process. In some examples, a spray head 128 may be implemented as a sprinkler head. In some examples, a spray head 128 may be implemented as a spray nozzle adapted to break up flow of water into a spray pattern. In such examples, a spray head 128 can be implemented as one or more of a flat fan nozzle, a hollow cone nozzle, a full cone nozzle, a misting nozzle, a solid stream nozzle, a tank cleaning nozzle, an air atomizing nozzle, a special purpose nozzle, and/or one or more other types of spray nozzles. In some examples, a spray head 128 can be implemented as some other type of water output device.

During the pasteurization process, the conveyor belt 126 conveys the vessel 122 containing the pasteurization article 120 through the pasteurization tunnel 124 as heated water is sprayed over the vessel 122 by the one or more spray heads 128. The control unit 102 can use the one or more pasteurization adjustment mechanisms 106 to adjust the spray water temperature, the belt speed, the belt direction, and/or one or more other parameters of the pasteurization process. For example, the pasteurization adjustment mechanisms 106 can include, but are not limited to, one or more spray water temperature controls 130 for adjusting temperature of the water output by the spray head 128, one or more belt speed controls 132 for adjusting the speed of the conveyor belt 126, and one or more belt direction controls 134 for adjusting the direction in which the conveyor belt 126 moves. Although FIG. 1 illustrates a pasteurization tunnel 124 as being used to implement the pasteurization process, persons skilled in the art will understand that a pasteurization tunnel is just one non-limiting example of a pasteurization system that can be used to implement a pasteurization process described herein.

Hereinafter, the one or more pasteurization sensors 104 may collectively be referred to as a single “pasteurization sensor 104” or as “pasteurization sensors 104.” In some examples, a pasteurization sensor 104 can be implemented as a resilient, food-grade sensor that is positioned within each can or bottle subjected to pasteurization. The pasteurization sensor 124 is engineered to withstand the high thermal conditions encountered during pasteurization and is adapted for continuously monitoring the internal thermal state or thermal gradient of the pasteurization article at single or numerous physical locations within the pasteurization. As opposed to traditional post-pasteurization testing methods, by using the pasteurization sensor 104 to monitor the pasteurization process in real-time, the pasteurization sensor 124 can gather instantaneous data on the efficacy of the microbial deactivation process, thereby increasing the probability of achieving desired safety standards during the pasteurization process.

In some examples, to address the challenges associated with data transmission through varying materials and environmental conditions encountered in pasteurization tunnels or fixtures, the pasteurization sensor 104 includes one or more antennas that employ a form of low-frequency wireless communication technology. For example, the antenna included in a pasteurization sensor 104 can implement one or more of radio-frequency identification (RFID) communication, low-frequency sub-GHz wireless communication, high frequency Bluetooth/Wi-Fi/ZigBee communications, or even proprietary low-frequency wireless solutions. In some examples, the antenna included in a pasteurization sensor 104 can transmit wireless signals that penetrate container and/or vessel materials, such as various types of glass, plastics, and/or metals. In some examples, the pasteurization sensor 104 is designed using a replica can or bottle to simulate the thermal mass and temperature gradients that would be experienced during any method of pasteurization.

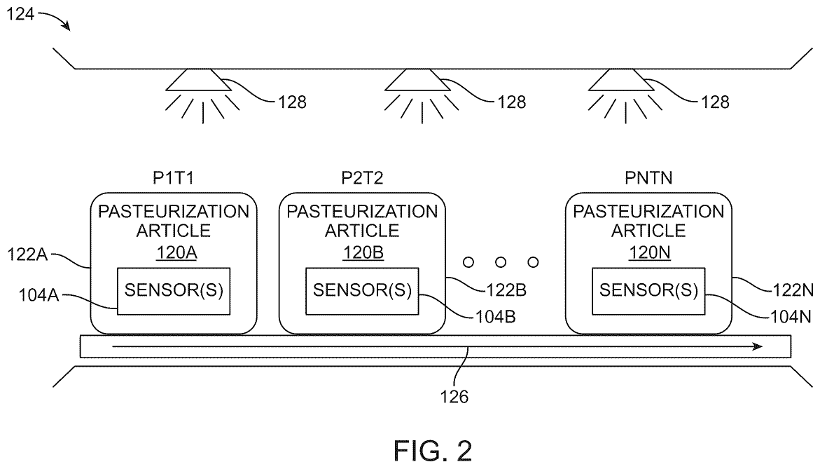

In some examples, the pasteurization sensor 104 includes and is powered by a primary or rechargeable battery. In other examples, the pasteurization sensor 104 is self-powered through thermal energy generation and harvesting. In this regard, the pasteurization sensor 104 can be wireless, mobile, and unencumbered by tethers that would restrict its ease of use and installation in the desired pasteurization method. For instance, in a tunnel pasteurization method such as the examples illustrated in FIGS. 1 and 2, pasteurization articles 120 enter from one side, and exit sometimes hundreds of feet away at another side. In such instances, reliance on cables or tethers to power a pasteurization sensor 104 could significantly restrict the ease of use, reliability, and safety of wired and/or tethered sensors.

Moreover, by using the wireless pasteurization sensors 104 described herein as opposed to traditional data logging and retrieval systems, the pasteurization sensors 104 can continuously generate data indicative of pasteurization process as experienced by the individual pasteurization article in real-time and transmit the generated data to control unit 102. In this regard, rather than using predetermined models and/or predictions, the control unit 102 can control, via the one or more pasteurization adjustment mechanisms 106, the pasteurization process based on the real-time data generated by the pasteurization sensors 104.

Upon receiving data from one or more pasteurization sensors 104, the control unit 102 can further process and analyze the received data. This analysis can include, but is not limited to, converting the received data (e.g., temperature data associated with the pasteurization article(s), pressure data associated with the pasteurization article(s), position data associated with the pasteurization article(s), etc.) into pasteurization units (PUs). The control unit 102 compares these PUs in real-time to a predefined set of expected values based on varying time and temperature parameters. In this regard, the control unit 102 can dynamically adjust one or more operational parameters (e.g., belt speed, direction, spray water temperature, and others) during the pasteurization process based on the real-time comparison of data received from the pasteurization sensors 104 to the predefined set of expected values. As described herein, the predefined set of expected values can be stored as one or more tables, thresholds, or other data structures in the memory 110 of control unit 102. Moreover, the memory 110 can store respective sets of expected PU values for each particular type of pasteurization article that can be pasteurized using the control system 100.

Pasteurization units (PUs) can be calculated using Equation 1 below:

$$PU = t \cdot {10}^{\frac{T - {T}_{ref}}{Z}} \qquad Equation 1$$

In Equation 1, “t” is the time in minutes during the pasteurization process, “T” is the temperature in Celsius of the pasteurization article and/or the environment surrounding the pasteurization article, “T_{ref}” is the reference temperature in Celsius, and “Z” is the coefficient of thermal resistance in Celsius. Different species of organisms have different thermal resistances, and thus different values for T_{ref} and Z. Choosing values appropriate for the type of beverage and/or food being pasteurized (and thus the types of organisms that like to live in that food) is therefore important. These values can be stored in memory 110 of the control unit 102 and selected for use by the control unit 102 based on the article that is being pasteurized.

In some examples, the sterilizing effect of various temperatures applied to brewing results in derived constants of T_{ref}=60 Celsius and Z=6.94 for use in brewing and fermented beverages. In such examples for brewing and fermented beverages, the PUs can be calculated using Equation 2 below:

$$PU = t \cdot {1.393}^{T - 60} \qquad Equation 2$$

In some examples, when the control unit 102 determines PU values in real time, the control unit 102 can further determine temperature ramp up and/or ramp down times for a pasteurization article during the pasteurization process. In some examples, the PU values are determined directly by the pasteurization sensor(s) 104. In other examples, the control unit 102 determines the PU values based on temperature data received from the pasteurization sensors 104.

In some examples, if the control unit 102 determines that the current temperature of a pasteurization article 120 is too low based on a comparison between the data received from a pasteurization sensor 104 and a predefined set of expected PU values stored in memory 110, the control unit 102 can use the one or more spray water temperature controls 130 to increase the temperature of water output by the one or more spray heads 128. As another example, if the control unit 102 determines that the current temperature of a pasteurization article 120 is too low based on a comparison between the data received from a pasteurization sensor 104 and a predefined set of expected PU values stored in memory 110, the control unit 102 can use the one or more belt speed controls 132 to decrease the speed of the conveyor belt 126 that is transporting the pasteurization article 120 through the pasteurization tunnel 124. As another example, if the control unit 102 determines that one or more steps in the pasteurization process have been skipped based on a comparison between the data received from a pasteurization sensor 104 and a predefined set of expected PU values stored in memory 110, the control unit 102 can use the one or more belt direction controls 134 to reverse the direction of the conveyor belt 126 that is transporting the pasteurization article 120 through the pasteurization tunnel 124.

In some examples, if the control unit 102 determines that the current temperature of a pasteurization article 120 is too high based on a comparison between the data received from a pasteurization sensor 104 and a predefined set of expected PU values stored in memory 110, the control unit 102 can use the one or more spray water temperature controls 130 to decrease the temperature of water output by the one or more spray heads 128. As another example, if the control unit 102 determines that the current temperature of a pasteurization article 120 is too high based on a comparison between the data received from a pasteurization sensor 104 and a predefined set of expected PU values stored in memory 110, the control unit 102 can use the one or more belt speed controls 132 to increase the speed of the conveyor belt 126 that is transporting the pasteurization article 120 through the pasteurization tunnel 124. As another example, if the control unit 102 determines that a pasteurization article 120 is falling behind in the pasteurization process based on a comparison between the data received from a pasteurization sensor 104 and a predefined set of expected PU values stored in memory 110, the control unit 102 can use the one or more belt speed controls 132 to increase the speed of the conveyor belt 126 that is transporting the pasteurization article 120 through the pasteurization tunnel 124.

Although the above examples were described with respect to a comparison between data received from a pasteurization sensor 104 and one or more expected PU values stored in memory 110, persons skilled in the art will appreciate that the control unit 102 can also and/or alternatively compare PU values calculated based on the data received from a pasteurization sensor 104 to one or more expected PU values stored in memory 110. Similarly, the control unit 102 can also and/or alternatively compare the data received from a pasteurization sensor 104 directly to one or more expected temperature values, pressure values, and/or position values stored in memory 110.

In some examples, an early warning system is integrated within the control system 100 to alert operators to instances in which the PUs for a particular pasteurization article deviate from expected values by more than a threshold amount. In some examples, the early warning system can be integrated within and/or coupled to the user interface 114 of the control unit 102. In some examples, the alert mechanism can include, but is not limited to, visual indicators and/or signals, auditory alarms, or automated messages to designated personnel either locally or remotely. The control unit 102 and/or one or more other devices in the control system 100 are adapted to activate the early warning system in response to instances in which the temperature, pressure, and/or PUs for a pasteurization article deviate from expected values. In that regard, operators can take corrective action to adjust the pasteurization process in response to activation of the early warning system.

In some examples, the control unit 102 is equipped with data storage and analytics capabilities for long-term trend analysis and process optimization. For example, the control unit 102 can store long-term trend data for pasteurization processes in memory 110 and optimize one or more parameters of a pasteurization process based on the long-term trend data. In some examples, the control unit 102 is further adapted to implement compliance and reporting features to aid in adherence to local, national, or international food safety standards. The adoption of such an integrated, real-time monitoring system can be pivotal in enhancing operational efficiencies, reducing resource wastage, ensuring regulatory compliance, and most critically, elevating the standard of food safety, thereby fostering increased consumer trust and brand loyalty.

FIG. 2 illustrates is a block diagram of an example pasteurization tunnel 124, according to various embodiments. In FIG. 2, a plurality of pasteurization articles 120A-120N are transported through the pasteurization tunnel 124 via conveyor belt 126 as part of the pasteurization process. As shown, the first pasteurization article 120A is contained within a first vessel 122A (e.g., a first can), the second pasteurization article 120B is contained within a second vessel 122B, and an Nth pasteurization article 120N is contained within an Nth vessel 122N. During the pasteurization process, spray heads 128 spray heated water over the pasteurization articles 120A-120N (e.g., over the vessels 122A-122N containing the pasteurization articles 120A-120N) to eliminate bacteria and/or other contaminants.

In the illustrated example of FIG. 2, a respective pasteurization sensor 104 is also disposed within each pasteurization article 120. For example, a first pasteurization sensor 104A is disposed within the first pasteurization article 120A, a second pasteurization sensor 104B is disposed within the second pasteurization article 120B, and an Nth pasteurization sensor 104N is disposed within the Nth pasteurization article 120N. During the pasteurization process, each of the pasteurization sensors 104A-104N generate data associated with the respective pasteurization articles 120A-120N in which they are disposed and wirelessly transmit the generated data to the control unit 102.

In the illustrated example of FIG. 2, the first pasteurization sensor 104A generates data indicative of the physical position P1 within the pasteurization tunnel 124 and/or the temperature T1 of the first pasteurization article 120A, the second pasteurization sensor 104B generates data indicative of the physical position P2 within the pasteurization tunnel 124 and/or the temperature T2 of the second pasteurization article 120B, and the Nth pasteurization sensor 104N generates data indicative of the physical position PN within the pasteurization tunnel 124 and/or the temperature TN of the Nth pasteurization article 120N. The control unit 102 can then use the one or more pasteurization adjustment mechanisms 106 to adjust one or more parameters (e.g., spray water temperature, belt speed, and/or belt direction) of the pasteurization process based on the position and/or temperature data received from the pasteurization sensors 104A-104N.

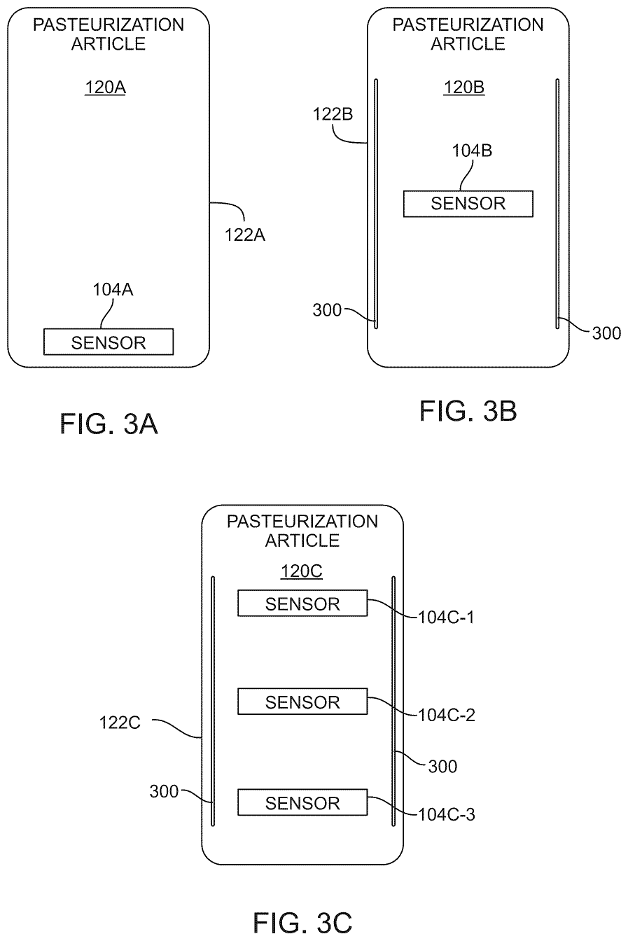

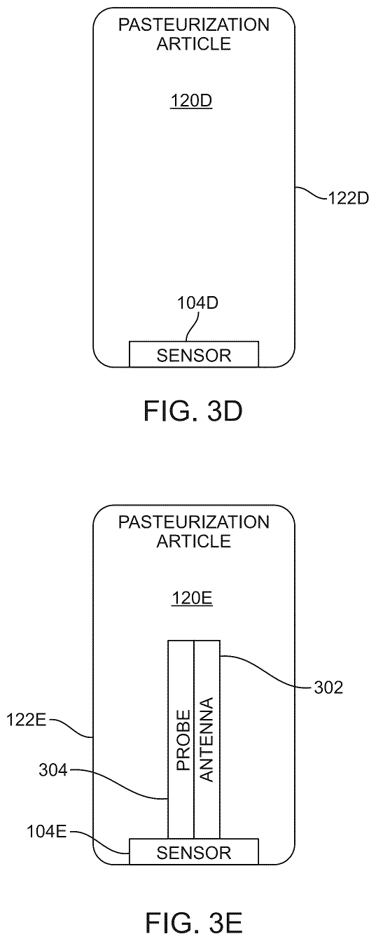

As described herein, a pasteurization sensor 104 can be placed and/or disposed directly within a pasteurization article 120 that is undergoing a pasteurization process. FIGS. 3A-3E illustrate various arrangements for a pasteurization sensor 104 disposed within a pasteurization article 120, according to various embodiments. Any of the arrangements of the pasteurization sensor 104 within the pasteurization article 120 shown in FIGS. 3A-3E can be implemented in the control system 100 of FIG. 1 and/or the pasteurization tunnel 124 of FIG. 2. Moreover, persons skilled in the art should understand that the arrangements of a pasteurization sensor 104 shown in FIGS. 3A-3E are non-limiting examples and that other arrangements not shown and/or described herein can also be used to place a pasteurization sensor 104 within a pasteurization article 120.

In a first example arrangement shown in FIG. 3A, a pasteurization sensor 104A is free-floating within a pasteurization article 120A contained within the vessel 122A. In a second example arrangement shown in FIG. 3B, a pasteurization sensor 104B is suspended in the middle of the pasteurization article 120B contained in vessel 122B by a support structure 300. In a third example arrangement shown in FIG. 3C, multiple pasteurization sensors 104C-1-104C-3 are suspended in the pasteurization article 120C contained in vessel 122C by a support structure 300. In a fourth example shown in FIG. 3D, a pasteurization sensor 104D is integrally formed within and/or coupled directly to the vessel 122D that contains pasteurization article 120D. In a fifth example arrangement shown in FIG. 3E, a pasteurization sensor 104E is integrally formed within and/or coupled directly to the vessel 122E that contains pasteurization article 120E. However, as further shown, the pasteurization sensor 104E includes an outwardly protruding antenna 302 and one or more additional sensor probes 304 positioned there along that provide numerous temperature sensing points for the pasteurization sensor 104E.

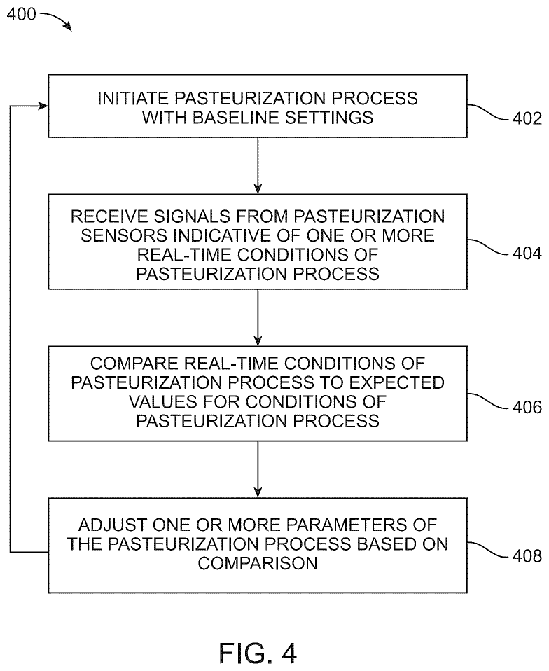

FIG. 4 is a flow diagram of method steps for controlling a pasteurization process, according to various embodiments. Although the method steps are described in conjunction with FIGS. 1-3, persons skilled in the art will understand that any system configured to perform the method steps, in any order, is within the scope of the present disclosure.

As shown, a method 400 begins at step 402, at which a controller initiates a pasteurization process with baseline, or standard, settings for one or more pasteurization parameters. For example, the control unit 102 initiates a pasteurization process for one or more pasteurization articles 120 by using standard settings for the speed of the conveyor belt 126, the direction of the conveyor belt 126, and/or the temperature of the water output by the spray heads 128. In some examples, the control unit 102 uses baseline settings that are particular to the type of pasteurization article 120 undergoing the pasteurization process.

At step 404, the controller receives one or more signals from pasteurization sensors that are indicative of real-time conditions of the pasteurization process. For example, the control unit 102 receives one or more signals that are wirelessly transmitted by a pasteurization sensor 104 disposed within a pasteurization article 120 that is undergoing the pasteurization process. The signal wirelessly transmitted by the pasteurization sensor 104 can include data indicative of the real-time conditions of the pasteurization process (e.g., conditions of the pasteurization article 120 itself and/or conditions of the environment surrounding the pasteurization article 120). In some examples, the data generated by a pasteurization sensor 104 can include the temperature of the pasteurization article 120 and/or the temperature of the environment surrounding the pasteurization article 120 (e.g., temperature of spray water, temperature of air in pasteurization tunnel, etc.), the pressure of the pasteurization article 120, the position of the pasteurization article 120 within a pasteurization tunnel 124 and/or some other location within a pasteurization facility, pasteurization units (PUs) for the pasteurization article 120, and/or some other conditions indicative of the pasteurization process.

At step 406, the controller compares the data indicative of real-time conditions of the pasteurization process to one or more expected values for conditions of the pasteurization process. For example, the control unit 102 compares the data received from the pasteurization sensor(s) 104 to a predefined set of expected values for conditions of the pasteurization process that are stored in memory 110. In some examples, the predefined set of expected values includes expected temperature values for the pasteurization article 120, an expected temperature value for the pasteurization article 120 at a particular time during the pasteurization process, expected pressure values for the pasteurization article 120, an expected pressure value for the pasteurization article 120 at a particular time during the pasteurization process, and/or an expected position of the pasteurization article 120. In some examples, the predefined set of expected values includes expected PU values that are based on varying time and temperature parameters. In such examples, the control unit 102 may calculate one or more PU values based on the data received from the pasteurization sensor(s) 104 and compare the calculated PU values to the expected PU values.

At step 408, the controller adjusts one or more parameters of the pasteurization process based on the comparison at step 406. For example, the control unit 102 adjusts, via one or more pasteurization adjustment mechanisms 106, one or more of the temperature of the spray water output by spray heads 128, the speed of the conveyor belt 126, and/or the direction of the conveyor belt 126 based on the comparison between the data indicative of real-time conditions of the pasteurization process received from the pasteurization sensor(s) 104 and the expected values for conditions of the pasteurization process.

In some examples, based on the comparison, the control unit 102 determines that the difference between the data received from the pasteurization sensor(s) 104 and expected values for conditions of the pasteurization process is less than a threshold amount. In such examples, the control unit 102 does not adjust one or more parameters of the pasteurization process.

In some examples, based on the comparison, the control unit 102 determines that the difference between the data received from the pasteurization sensor(s) 104 and expected values for conditions of the pasteurization process is greater than a threshold amount. In such examples, the control unit 102 adjusts one or more parameters of the pasteurization process to bring the real-time conditions of the pasteurization process closer to the expected values for conditions of the pasteurization process. For example, the control unit 102 can increase the temperature of water output by spray heads 128 (e.g., via one or more spray water temperature controls 130) and/or decrease the speed of the conveyor belt 126 (e.g., via one or more belt speed controls 132) in response to determining, based on the comparison, that the temperature of the pasteurization article 120 is too low. As another example, the control unit 102 can decrease the temperature of water output by spray heads 128 (e.g., via one or more spray water temperature controls 130) and/or increase the speed of the conveyor belt 126 (e.g., via one or more belt speed controls 132) in response to determining, based on the comparison, that the temperature of the pasteurization article 120 is too high.

Furthermore, in some examples in which the control unit 102 determines that the difference between the data received from the pasteurization sensor(s) 104 and expected values for conditions of the pasteurization process is greater than a threshold amount, the control unit 102 further activates the early warning system described herein.

### Pasteurization Sensor Assembly

As described herein, it can be difficult to measure the progress of pasteurization in packaged food and beverages with traditional systems and methods. In some examples, a common approach to measuring pasteurization progress of a packaged food and/or beverage includes placing a temperature sensor, or probe, at an expected “cold spot” inside the vessel (e.g., bottle, can, jar, etc.) in which the article (e.g., food, beverage, etc.) being pasteurized is packaged. The expected cold spot inside the vessel typically corresponds to the lowest point, or depth, within the vessel that will be heated last during pasteurization.

However, at least one drawback to this approach is that the accuracy with which pasteurization can be monitored using this approach is contingent on proper placement of the temperature probe within the vessel. In that regard, if the temperature probe is placed incorrectly within the vessel, progress of the pasteurization cannot accurately be determined. Moreover, at least another drawback to this approach is that a single temperature probe placed in a cold spot of the pasteurization article contained in the vessel cannot reliably be used to measure pasteurization of the article throughout the entire vessel (e.g., at higher depths within the vessel).

To address these above-described problems, with the disclosed techniques, temperature can be measured at several fixed distances, or depths, within the vessel using a plurality of temperature probes. By measuring temperature at multiple locations within the vessel, the cold spot within the vessel can be determined indirectly, or inferred, based on the various temperature measurements. In that regard, temperature of the cold spot within the vessel can be determined without relying on an operator guessing the location of the cold spot.

Furthermore, the temperature measurements taken at multiple locations (e.g., depths) within the vessel can be used to determine temperature gradients within the pasteurization article contained in the vessel in real time, thereby providing further insight into the speed and effectiveness of the pasteurization process. In some examples, in addition to the temperature of the pasteurization article within the vessel, temperature of the spray watercan be measured and/or pressure within the vessel can be measured during a pasteurization process.

FIG. 5 is a block diagram of a pasteurization sensor assembly 500, according to various embodiments. The pasteurization sensor assembly 500 can be used to implement a pasteurization sensor 104 described herein with respect to FIGS. 1-4. In that regard, the pasteurization sensor assembly 500 can be disposed within a pasteurization article 120 and communicate, in real-time, data indicative of conditions of the pasteurization process to the control unit 102. Moreover, persons skilled in the art will understand that the description of the pasteurization sensor assembly 500 can also be applied to the pasteurization sensors 104 described herein.

As shown in FIG. 5, the pasteurization sensor assembly 500 includes a module housing 502 that contains a battery and/or capacitor that powers the pasteurization sensor assembly 500, a processor that controls operations of the pasteurization sensor assembly 500, and a wireless communication circuit that enables the pasteurization sensor assembly 500 to transmit generated sensor data to a controller, such as the control unit 102. The wireless communication circuit can use one or more of radio-frequency identification (RFID) communication, low-frequency sub-GHz wireless communication, high frequency Bluetooth/Wi-Fi/ZigBee communications, and/or even proprietary low-frequency wireless solutions to communicate with the control unit 102. In some examples, a spray water temperature sensor 504 can also be disposed on the module housing 502 for measuring the temperature of the water output by spray heads 128 during pasteurization.

As further shown in FIG. 5, the pasteurization sensor assembly 500 includes an elongated stem portion, or probe 506, that extends outward from the module housing 502. A plurality of temperature sensors 508A-508E are disposed along the probe 506 to respectively measure temperatures at various locations. For example, the multiple temperature sensors 508A-508E can be spaced apart at fixed distances along the probe 506. In that regard, when the probe 506 of the pasteurization sensor assembly 500 is inserted into a vessel 122 that contains a pasteurization article 120, each temperature sensor 508 on the probe 506 can sense a temperature of the pasteurization article 120 at a different respective depth within the vessel 122.

As further shown in FIG. 5, a pressure sensor 510 can be disposed at the bottom of the probe 506. In some examples, the pressure sensor 510 is adapted to sense a pressure, or force, of the probe 506 pressing against a bottom and/or side surface of the vessel 122 in which the pasteurization sensor assembly 500 is inserted. In that regard, the processor of the pasteurization sensor assembly 500 can determine whether the probe 506 is properly inserted in the vessel 122 based on the data generated by the pressure sensor 510. For example, when the pressure data exceeds a threshold, the processor of the pasteurization sensor assembly 500 can determine that the probe 506 is properly installed and the temperature sensors 508A-508E are positioned at the correct depths within the vessel 122. In other examples, the pressure sensor 510 generates pressure data indicative of the pressure of the pasteurization article 120 contained within the vessel 122 in which the pasteurization sensor assembly 500 is inserted.

During use of the pasteurization sensor assembly 500, the spray water temperature sensor 504, the temperature sensors 508A-508E, and/or the pressure sensor 510 can generate data and transmit the generated data to the processor disposed in the module housing 502. In some examples, the processor can then use the wireless communication circuit disposed in the module housing 502 to transmit the data generated by the spray water temperature sensor 504, the temperature sensors 508A-508E, and/or the pressure sensor 510 to the control unit 102. In such examples, the control unit 102 can adjust one or more parameters of a pasteurization process based on the data generated by and received from the pasteurization sensor assembly 500 as described herein with respect to FIGS. 1-4.

In some examples, the processor of the pasteurization sensor assembly 500 can analyze the data generated by the spray water temperature sensor 504, the temperature sensors 508A-508E, and/or the pressure sensor 510 before and/or after transmitting data to the control unit 102. In such examples, the processor can determine one or more parameters indicative of the progress of the pasteurization process based on the data generated by the spray water temperature sensor 504, the temperature sensors 508A-508E, and/or the pressure sensor 510. For example, the processor can determine the location and/or temperature of a cold spot within the vessel 122 in which the pasteurization sensor assembly 500 is installed based on the temperature and/or pressure data received from the one or more sensors. As another example, the processor can determine how much time remains in the pasteurization process and/or if the pasteurization process is complete based on the temperature and/or pressure data received from the one or more sensors. In some examples, the processor can transmit messages that are indicative of the progress of the pasteurization process to a remote computing device, such as the control unit 102, using the wireless communication circuit. In some examples, the processor can transmit messages that are indicative of the cold spot within the vessel 122 to a remote computing device, such as the control unit 102, using the wireless communication circuit.

In the illustrated example of FIG. 5, five temperature sensors 508A-508E are disposed along the probe 506. However, persons skilled in the art should understand that, in other examples, fewer (e.g., two, three, or four) or more (e.g., six, seven, eight, etc.) than five temperature sensors 508 can be disposed along the probe 506. Furthermore, persons skilled in the art should understand that, in some examples, more than one pressure sensor 510 can be disposed on the probe 506 of the pasteurization sensor assembly 500. Moreover, although shown as being disposed at the bottom of the probe 506, one or more pressure sensors 510 can be disposed along the probe 506 at various other locations. In some examples, the length of the probe 506 can be designed based on the size of the vessel 122 in which the probe 506 will be inserted.

In some examples, the module housing 502 further contains an accelerometer and/or some other suitable type of sensor that is adapted to detect and/or track movement of the pasteurization sensor assembly 500. In such examples, while the probe 506 of the pasteurization sensor assembly 500 is inserted in a vessel 122 containing a pasteurization article 120, the accelerometer can track movement of the vessel 122 throughout the pasteurization process. Tracking movement of the vessel 122 that contains the pasteurization article 120 during a pasteurization process can be especially beneficial for pasteurization processes/systems, such as ones that include a pasteurization tunnel 124, in which the vessel moves throughout the pasteurization system and/or makes multiple stops during the pasteurization process. In that regard, the processor of the pasteurization sensor assembly 500 and/or the control unit 102 that is wirelessly coupled to the pasteurization sensor assembly 500 can receive data generated by the accelerometer and map the route of the vessel 122 during the pasteurization process. In some examples, the control unit 102 wirelessly coupled to the pasteurization sensor assembly 500 can use measurements generated by the accelerometer to determine and/or map distances between respective stops by the vessel 122 during the pasteurization process.

In some examples, based on data generated by the accelerometer, the temperature sensors 508A-508D, and/or the pressure sensor 510, the processor of the pasteurization sensor assembly 510 and/or the control unit 102 wirelessly coupled to the pasteurization sensor assembly 500 can model and/or control the pasteurization process as a function of time, temperature, and position of the vessel 122 within a pasteurization tunnel 124 or other similar equipment. In such examples, the control unit 102 can present, via the user interface 114, a model of the pasteurization process to an operator.

In some examples, the accelerometer included in the pasteurization sensor assembly 500 can detect one or more vibrations in the pasteurization article 120 and/or the vessel 122. For example, as the vessel 122 containing the pasteurization article 120 moves through the pasteurization tunnel 124 during a pasteurization process, the accelerometer can detect when vibrations in the pasteurization article 120 and/or the vessel 122 exceed a threshold. In some examples, when vibration in the pasteurization article 120 and/or the vessel 122 exceeds a threshold as the vessel 122 moves through a pasteurization tunnel 124, the cause could be a failure or maintenance issue associated with the pasteurization tunnel 124. In that regard, when the control unit 102 maps the route of the vessel 122 during the pasteurization process, the control unit 102 can map locations within the pasteurization tunnel 124 that correspond to increased vibrations sensed by the accelerometer included in the pasteurization sensor assembly 500. Accordingly, maintenance personnel can refer to the mapped route of the vessel 122 during the pasteurization process to identify locations within and/or components of the pasteurization tunnel 124 in need of servicing or repair.

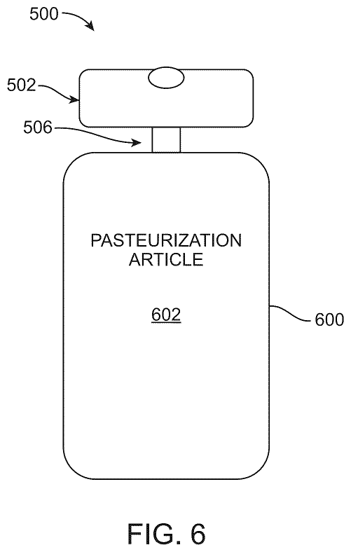

FIG. 6, illustrates an example in which the pasteurization sensor assembly 500 of FIG. 5 is inserted in a first vessel 600 filled with a pasteurization article 602, according to various embodiments. The first vessel 600 is, for example, an aluminum can and the pasteurization article 602 contained in the first vessel 600 can be, for example, one or more of an alcoholic beverage, a soft drink, coffee, or some other beverage. During pasteurization of the pasteurization article 602, the temperature sensors 508A-508E disposed along the probe 506 of the pasteurization sensor assembly 500 can sense respective temperatures at various depths within the first vessel 600.

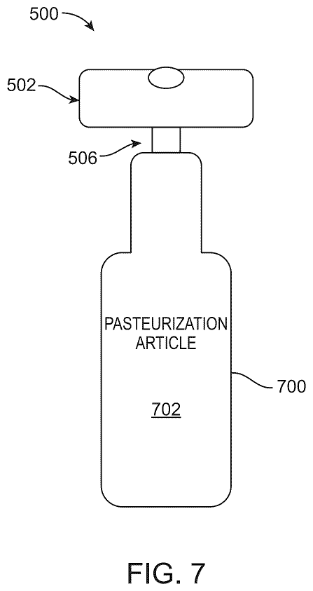

FIG. 7 illustrates an example in which the pasteurization sensor assembly 500 of FIG. 5 is inserted in a second vessel 700 filled with a pasteurization article 702, according to various embodiments. The second vessel 700 is, for example, a glass bottle and the pasteurization article 702 contained in the second vessel 700 can be, for example, one or more of an alcoholic beverage, a soft drink, a dairy product, or some other beverage. During pasteurization of the pasteurization article 702, the temperature sensors 508A-508E disposed along the probe 506 of the pasteurization sensor assembly 500 can sense respective temperatures at various depths within the second vessel 700.

When compared to traditional approaches to measuring the temperature of a pasteurization article, the pasteurization sensor assembly 500 described herein offers at least the following technical advantages. The pasteurization sensor assembly 500 is lightweight and the thin, elongated shape of the probe 506 displaces a minimal amount of fluid volume within a pasteurization article 120 and/or vessel 122. Furthermore, because the pasteurization sensor assembly 500 can simply be inserted into the top of a vessel (e.g., vessel 122, first vessel 600, second vessel 700, or some other vessel), use of the pasteurization sensor assembly 500 does not require heavy, expensive sleds and/or mounting mechanisms. At least another advantage is that the pasteurization sensor assembly 500 can measure both temperature and pressure within a vessel. Moreover, as opposed to traditional approaches, the pasteurization sensor assembly 500 can measure temperature at multiple locations, or depths, within a vessel and can measure the temperature of heated water output by the spray heads 128 during pasteurization. In addition, the pasteurization sensor assembly 500 is relatively low cost, can be used at scale, and allows for wireless communication that is powered by a battery, thereby allowing the pasteurization sensor assembly 500 to be installed in any location without relying on a wired power or communication connection.

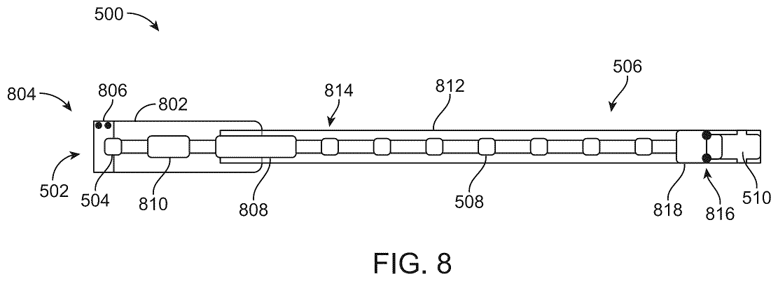

FIG. 8 illustrates a cross-section view of the pasteurization sensor assembly 500 of FIG. 5, according to various embodiments. As shown in FIG. 8, the module housing 502 comprises a plastic housing portion 802 and a metal cap 804 disposed on top, or at an outer surface, of the plastic housing 802. A pair of positive and negative metal contacts 806, which are used to charge the power supply 808 in the pasteurization sensor assembly 500, are disposed on and/or accessible via the plastic housing 804. As described herein, the power supply 808 included in the pasteurization sensor assembly 500 can include a rechargeable battery and/or a capacitor.

The plastic housing 802 protects the processor, the wireless communication circuit (e.g., radio) and antenna, the power supply 808, and the accelerometer from water output by the spray heads (e.g., spray heads 128) during a pasteurization process. In FIG. 8, the processor, the wireless communication circuit (e.g., radio) and antenna, and the accelerometer are represented by a control circuit 810 disposed within the plastic housing 802. In addition, the plastic housing 802 can further provide protection for the spray water temperature sensor 504. As shown in FIG. 8, the spray water temperature sensor 504 is in thermal contact with the metal cap 804 disposed on top of the plastic housing 802, thereby enabling the spray water temperature sensor 504 to sense the temperature of spray water via the metal cap 804. In some examples, the plastic housing 802 is made from a different material, such as rubber or some other non-conductive and/or insulating material.

As further shown in FIG. 8, a printed circuit board (PCB) 812 extends through the interior of the pasteurization sensor assembly 500 from the module housing 502 to the end of the probe 506. In that regard, the electronic components and/or sensors in the pasteurization sensor assembly 500 are disposed on and/or are coupled to the PCB 812 that extends through the interior of the pasteurization sensor assembly 500. For example, the spray water temperature sensor 504, the power supply 808, and the control circuit 810 are disposed on and/or are coupled to the PCB 812 within the interior of the module housing 502. As another example, the plurality of temperature sensors 508 and the pressure sensor(s) 510 are disposed on and/or are coupled to the PCB 812 within the interior of the probe 506 of the pasteurization sensor assembly 500. In some examples, the plurality of temperature sensors 508, the pressure sensor(s) 510, and/or the accelerometer are electrically connected to the processor via the PCB 812.

As further shown in FIG. 8, the probe 506 comprises a metal tube 814 that surrounds the PCB 812 and the temperature sensors 508 disposed therein. In that regard, the metal tube 814 separates the PCB 812, the temperature sensors 508, the pressure sensor(s) 510, and/or other electronic components of the pasteurization sensor assembly 500 from the pasteurization article (e.g., food, beverage, etc.) in which the probe 506 is inserted. Furthermore, an O-ring seal 816 and/or an epoxy seal 818 can be used to seal the end of the probe 506 from the pasteurization article in which the probe 506 is inserted. For example, as shown in FIG. 8, an O-ring seal 816 and an epoxy seal 818 are used to seal the end, or bottom, of the metal tube 814 thereby preventing the pasteurization article from entering the metal tube 814 and damaging the temperature sensors 508, the pressure sensor(s) 510, the PCB 812, and/or other electronics disposed therein.

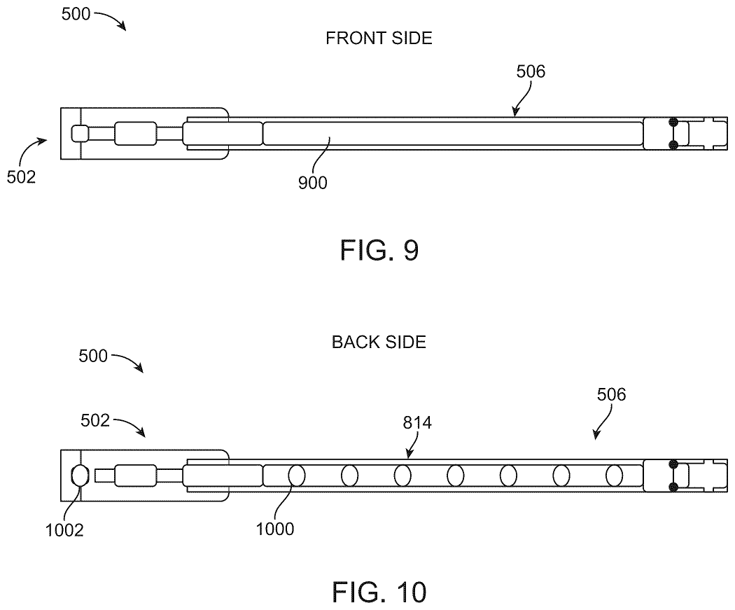

In some examples, an insulating cover and/or sleeve is disposed between the metal tube 814 of the probe 506 and the PCB 812 and/or temperature sensors 508 positioned inside the metal tube 814. In this arrangement, the insulating cover slows down thermal distribution from the metal tube 814 to the temperature sensors 508 and/or the PCB 812 disposed therein. Stated another way, in some examples, the pasteurization sensor assembly 500 includes a temperature insulator that prevents the metal tube 814 from directly contacting the PCB 812 and/or the temperature sensors 508 disposed within the metal tube 814. FIG. 9 illustrates a cross-section view of a front side of the pasteurization sensor assembly 500 in which a thermal insulator 900 is shown, according to various embodiments. As shown in FIG. 9, the thermal insulator 900 covers the PCB 812 and temperature sensors 508. In that regard, the thermal insulator 900 separates the metal tube 814 from the temperature sensors 508 and/or the PCB 812.

FIG. 10 illustrates a cross-section view of a back side of the pasteurization sensor assembly 500 of FIG. 5, according to various embodiments. As shown in FIG. 10, a plurality of copper spring contacts 1000 couples the edge of the metal tube 814 of the probe 506 to the plurality of temperature sensors 508 disposed along the probe 506. For example, each copper spring contact 1000 is respectively disposed on and/or abutted against an edge of the metal tube 814 and coupled to a respective temperature sensor 508 via one or more heat traces. In that regard, the plurality of temperature sensors 508 can generate a more discrete set of temperature measurements along the length of the probe 506. As further shown in FIG. 10, a copper spring contact 1002 is also included in the module housing 502 and couples the metal cap 804 on top of the plastic housing 802 to the spray water temperature sensor 504. For example, the copper spring contact 1002 is coupled to the spray water temperature sensor 504 via one or more heat traces.

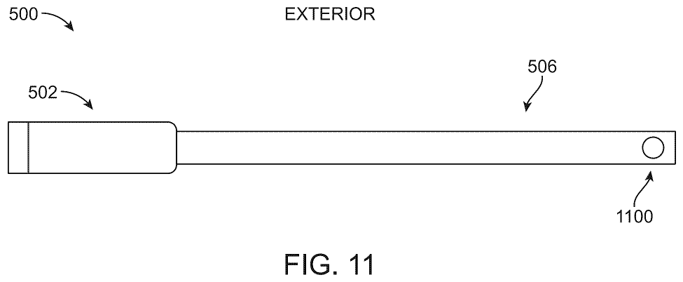

FIG. 11 illustrates a side view of the exterior of the pasteurization sensor assembly 500 of FIG. 5, according to various embodiments. As shown in FIG. 11, a hole 1100 is formed in the end of the probe 506. This hole 1100 enables the pressure sensor 510 disposed at the end of the probe 506 to sense pressure when the probev 506 touches the bottom of the vessel in which the probe 506 is inserted.

FIG. 12 illustrates a cross-section view in which a sensor insertion mechanism 1200 is installed on a vessel 1202 containing a pasteurization article, according to various embodiments. The sensor insertion mechanism 1200 can be, for example, used to insert the probe 506 of pasteurization sensor assembly 500 into the vessel 1202. As shown, the insertion mechanism 1200 can be used to pierce a surface (e.g., a top surface) of the vessel 1200. Moreover, the sensor insertion mechanism 1200 includes a gland 1204 having rubber membrane. Once the sensor insertion mechanism 1200 has pierced the top of the vessel 1202, the probe 506 of the pasteurization sensor assembly 500 can be inserted into the vessel 1202 via the gland 1204. In the illustrated example of FIG. 12, the sensor insertion mechanism 1200 is shaped like a spike or funnel. However, in other examples, the sensor insertion mechanism 1200 can have a different shape. In some examples, the sensor insertion mechanism 1200 is intended for single use and can be discarded after pasteurization of the article contained in the vessel 1202 is complete. In other examples, the sensor insertion mechanism 1200 is reusable.

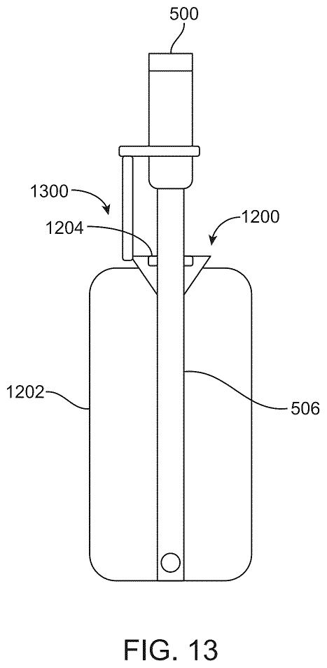

FIG. 13 illustrates a cross-section view in which the pasteurization sensor assembly 500 of FIG. 5 is inserted in a vessel 1202 via the sensor insertion mechanism 1202 of FIG. 12, according to various embodiments. As shown, the probe 506 of the pasteurization sensor assembly 500 is inserted into the vessel 1202 by breaking the gland 1204 of the sensor insertion mechanism 1200 and inserting the probe 506 through the gland 1204. The rubber membrane of the gland 1204 creates a leak proof seal around the probe 506 while the probe 506 is inserted in the vessel 1202. In that regard, water output by spray heads (e.g., water spray heads 128) is prevented from entering the vessel 1202 during pasteurization.

In some examples, the sensor insertion mechanism 1200, via the gland 1204 with the rubber membrane, can create a permanent or semi-permanent bond between the vessel 1202 and the pasteurization sensor assembly 500. In this regard, the vessel 1202 remains sealed throughout the entire pasteurization process (either tunnel or batch). In some examples, the sensor insertion mechanism 1200 contains a plurality of gaskets and sealing components (e.g., rubber membranes, O-rings, etc.). In such examples, when the sensor insertion mechanism 1200 is used to pierce the vessel 1202, very little to no media (e.g., pasteurization article such as a beverage or food) and/or pressurized gas can escape the vessel 1202.

As further shown in FIG. 13, in some examples, one or more support structures 1300 can be used to hold the pasteurization sensor assembly 500 in place relative to the vessel 1202 while the probe 506 is inserted in the vessel 1202. The one or more support structures 1300 can, for example, prevent the probe 506 from being forced out of the vessel 1202 by the pressure of the article being pasteurized. Moreover, the one or more support structures 1300 can help support the pasteurization sensor assembly 500 in an upright position.

FIG. 14A illustrates a side view in which the pasteurization sensor assembly 500 of FIG. 5 is inserted in a vessel 1400 via the sensor insertion mechanism 1200 of FIG. 12, according to various embodiments. FIG. 14B illustrates a top-down view in which the pasteurization sensor assembly 1200 of FIG. 5 is inserted in a vessel 1400 via the sensor insertion mechanism 1200 of FIG. 12, according to various embodiments.

FIG. 15 illustrates a pasteurization system 1500, according to various embodiments. In some examples, the pasteurization system 1500 may be implemented as part of a pasteurization tunnel, such as pasteurization tunnel 124. In other examples, the pasteurization system 1500 can be implemented as standalone pasteurization system.

As shown in FIG. 15, the example pasteurization system includes a sensor module 1502, a spray head 1504, and a vessel 1506 (e.g., a can, a bottle, a jar, or some other vessel) that contains an article (e.g., a beverage or food) to be pasteurized. In operation, the spray head 1504 sprays the vessel 1506 with heated water. The sensor module 1502, which can be similar to the pasteurization sensor 104 and/or the pasteurization sensor assembly 500 described herein, includes and/or is connected to various sensors that can be used to generate data indicative of one or more conditions of a pasteurization process in real-time. For example, the sensor module 1502 includes and/or is coupled to one or more temperature sensors and/or one or more pressure sensors that are adapted to generate data indicative of one or more conditions of the pasteurization process.

The sensor module 1502 can further include and/or be connected to a control unit, such as the control unit 102 described herein. In that regard, the control unit included in and/or connected to the sensor module 1502 is adapted to analyze the data generated by the one or more sensors included in and/or coupled to the sensor module 1502 by comparing the data to expected PU levels for the particular pasteurization article contained in the vessel 1506. The control unit included in and/or connected to the sensor module 1502 is further adapted to dynamically adjust one or more operational parameters (e.g., belt speed, direction, spray water temperature, and others) of the pasteurization process based on the comparison between the data generated by the one or more sensors included in and/or coupled to the sensor module 1502 and the expected PU levels for the particular pasteurization article contained in the vessel 1506. As described herein, adjusting one or more operation parameters of the pasteurization process can include adjusting the temperature of water output by the spray head 1504, changing speed of a conveyor belt, and/or changing direction of a conveyor belt. By adjusting one or more parameters of the pasteurization process, the control unit included in and/or connected to the sensor module 1502 can improve efficiency of the pasteurization process, minimize energy consumption during the pasteurization process, and/or maximize product safety of the canned beverage.

The sensor module 1502 is engineered to withstand the high thermal conditions encountered during pasteurization. For example, the sensor module 1502 can withstand the high-temperature water that is released from the spray head 1504 during pasteurization. The base and/or housing of the sensor module 1502 can be constructed from, for example but without limitation, metal injected molded M24. In some examples, the sensor module 1502 can include one or more of a radio frequency (RF) circuit, a sensor interface that connects to one or more sensors included in the sensor module 1502 and/or external to the sensor module 1502, a battery for powering the sensor module 1502, one or more light emitting diodes (LEDs), and/or one or more other electronics.

As further shown in FIG. 15, the pasteurization system 1500 includes a support structure 1508 for holding the vessel 1506 that contains the pasteurization article in place. The support structure 1508 includes, for example, threaded stainless-steel (SS) rods 1510, compression clamps 1512, and a top plate 1514. The threaded stainless-steel rods 1510 are disposed on opposite sides of the vessel 1506, and fasteners 1516 threaded onto the respective threaded stainless-steel rods 1510 can be adjusted in accordance with the height of the vessel 1506. In that regard, the top plate 1514 can be supported by the fasteners 1516 threaded on the stainless-steel rods 1510 on the top surface of the vessel 1506. The compression clamps 1512, which can be selectively locked by one or more levers, clamp the top plate down 1514 onto the top surface of the vessel 1506 thereby pressing the bottom of the vessel 1506 onto a piercing mechanism further holding the vessel 1506 in place with respect to the piercing mechanism. The piercing mechanism and the support structure 1508 are supported by and/or extend upward from a base plate 1518 mounted to a skid plate 1520 of the pasteurization system 1500. In some examples, a splash shield and/or a splash tube may further be place proximate the support structure 1508 for the vessel 1506 that contains the article to be pasteurized.

In the pasteurization system 1500, each of the components are mounted to and/or otherwise supported by the base plate 1518 and/or the skid plate 1520. For example, the sensor module 1502, the spray head 1504, and/or the support structure 1508 are mounted to and/or otherwise supported by the base plate 1518 and/or the skid plate 1520.

FIG. 16 illustrates a cross-section view of the pasteurization system 1500 of FIG. 15, according to various embodiments. As shown in FIG. 16, the sensor module 1502 is connected, or communicatively coupled, to a spray water temperature sensor 1600 disposed within and/or on the spray head 1504. The sensor module 1502 is connected to the spray water temperature sensor 1600, for example, via a bus connection 1602 (e.g., an I2C bus connection). The spray water temperature sensor 1600 is positioned and/or adapted to sense the temperature of the water that is sprayed from the spray head 1504 onto the vessel 1506 that contains the article to be pasteurized. As described herein, the control unit (e.g., control unit 102) disposed within and/or coupled to the sensor module 1502 can use data generated by the spray water temperature sensor 1600 to control one or more operational parameters of the pasteurization process. In some examples, the spray water temperature sensor 1600 can be implemented as a digital temperature sensor, such as but not limited to, a digital resistance temperature detector (RTD). In some examples, the spray water temperature sensor 1600 receives operational power from the sensor module 1502.

As further shown in FIG. 16, the sensor module 1502 is further connected, or communicatively coupled, to a pasteurization temperature sensor 1604. The pasteurization temperature sensor 1604 may be similar in construction and/or operation to one of the pasteurization temperature sensors 104 described herein. The sensor module 1502 is connected to the pasteurization temperature sensor 1604, for example, via the bus connection 1602 (e.g., an I2C bus connection). The pasteurization temperature sensor 1604 is positioned and/or adapted to sense a temperature of the pasteurization article contained in the vessel 1506. In some examples, the pasteurization temperature sensor 1604 can be implemented as a digital temperature sensor, such as but not limited to, a digital RTD. In some examples, the pasteurization temperature sensor 1604 receives operational power from the sensor module 1502.

In the illustrated example of FIG. 16, the pasteurization temperature sensor 1604 is disposed atop a PCB mount 1606 positioned beneath the vessel 1506. Moreover, in the illustrated example of FIG. 16, the pasteurization temperature sensor 1604 is disposed within and/or is in thermal contact with a piercing mechanism 1608 (e.g., a metal needle or spike) that pierces the bottom surface of the vessel 1506. In that regard, the pasteurization temperature sensor 1604 generates temperature data that is indicative of the temperature of the pasteurization article contained inside the vessel 1506. The pasteurization temperature sensor 1604 transmits temperature data generated by the pasteurization temperature sensor 1604 to the control unit (e.g., control unit 102) disposed within and/or connected to the sensor module 1502. As described herein, the control unit disposed within and/or coupled to the sensor module 1502 can use data generated by the pasteurization temperature sensor 1604 to control one or more operational parameters of the pasteurization process. In some examples, one or more offset algorithms can be used by the control unit to normalize pasteurization temperature measurements with respect to temperature measurements associated with the piercing mechanism 1608 and/or copper components of the pasteurization system 1500.

As further shown in FIG. 16, the pasteurization system 1500 includes a rubber seal 1610 that is disposed beneath the bottom of the vessel 1506 and around the piercing mechanism 1608. The rubber seal 1610 forms a seal, for example, between the piercing mechanism 1608 and a hole formed in the bottom of the vessel 1506 by the piercing mechanism 1608. In that regard, the rubber seal 1610 prevents leakage of the pasteurization article from the vessel 1506 and water sprayed by the spray head 1504 from entering the vessel 1506. As further shown in FIG. 16, the vessel 1506 rests atop the plastic base plate 1518. The plastic base plate 1518 insulates the bottom of the vessel 1506 and is supported on the stainless-steel skid plate 1520.

As described above and shown in the illustrated example of FIG. 16, the vessel 1506 is held in place by the support structure 1508. The threaded stainless-steel rods 1510 are disposed on opposite sides of the vessel 1506, the top plate 1514 can be supported by the fasteners 1516 threaded on the stainless-steel rods 1510 on the top surface of the vessel 1506. The compression clamps 1512, which can be selectively locked by one or more levers, clamp the top plate 1514 down onto the top surface of the vessel 1506 thereby pressing the bottom of the vessel 1506 onto the piercing mechanism 1608 and further holding the vessel 1506 in place with respect to the piercing mechanism 1608. In some examples, a splash shield and/or a splash tube can further be placed proximate the support structure 1508 for the vessel 1506.

FIG. 17 illustrates an example pasteurization system 1700, according to various other embodiments. The pasteurization system 1700 of FIG. 17 includes similar components as the pasteurization system 1500 shown in FIG. 15 and described herein. However, as shown in FIG. 17, the pasteurization system 1700 is supported on a machined plastic sled 1702 that reduces the thermal temperature impact on sensors (e.g., spray water temperature sensor 1600, pasteurization temperature sensor 1604, etc.) included in the pasteurization system 1700. The machined plastic sled 1702 comprises handles 1704 disposed on opposing sides of the sled 1702 that provide for easy handling.

FIG. 18 illustrates an example pasteurization system 1800, according to various other embodiments. The pasteurization system 1800 differs from other pasteurization systems described herein in that a cylindrical support base 1802, not an upright support structure, is used to support the vessel 1506 that contains the article to be pasteurized. Moreover, respective handles 1804 and 1806 are formed integrally with and/or attached to the plastic base plate 1518.

1. In some embodiments, a pasteurization control system comprising an adjustment mechanism adapted to adjust a pasteurization parameter; a sensor adapted to sense a pasteurization condition; and a controller coupled to the adjustment mechanism and the sensor, wherein the controller is adapted to initiate a pasteurization process in accordance with a baseline setting for the pasteurization parameter, receive data indicative of the pasteurization condition from the sensor, and modify, via the adjustment mechanism, the pasteurization parameter based on a comparison between the data indicative of the pasteurization condition and an expected value for the pasteurization condition.

2. The system of clause 1, wherein the sensor is a temperature sensor; wherein the pasteurization condition is a temperature of an article undergoing the pasteurization process; and wherein the sensor is disposed within a vessel that contains the article undergoing the pasteurization process.

3. The system of clauses 1 or 2, further comprising a spray head adapted to spray water over the article undergoing the pasteurization process; and wherein the pasteurization parameter is a temperature of the water sprayed over the article undergoing the pasteurization process.

4. The system of any of clauses 1-3, wherein to modify the pasteurization parameter based on the comparison, the controller is adapted to increase the temperature of the water sprayed over the article undergoing the pasteurization process when the temperature of the article undergoing the pasteurization process is less than the expected value by a threshold amount.

5. The system of any of clauses 1-4, wherein to modify the pasteurization parameter based on the comparison, the controller is adapted to decrease the temperature of the water sprayed over the article undergoing the pasteurization process when the temperature of the article undergoing the pasteurization process is greater than the expected value by a threshold amount.

6. The system of any of clauses 1-5, further comprising a conveyor belt adapted to transport a vessel that contains the article undergoing the pasteurization process; and wherein the pasteurization parameter is a speed of the conveyor belt.

7. The system of any of clauses 1-6, wherein to modify the pasteurization parameter based on the comparison, the controller is adapted to decrease the speed of the conveyor belt when the temperature of the article undergoing the pasteurization process is less than the expected value by a threshold amount.

8. The system of any of clauses 1-7, wherein to modify the pasteurization parameter based on the comparison, the controller is adapted to increase the speed of the when the temperature of the article undergoing the pasteurization process is greater than the expected value by a threshold amount.

9. The system of any of clauses 1-8, wherein the controller is connected to the sensor via a wireless connection.

10. The system of any of clauses 1-9, wherein the sensor is disposed within a vessel that contains an article undergoing the pasteurization process.

11. In some embodiments, a method for controlling a pasteurization process comprises operating a pasteurization control device in accordance with a baseline setting; receiving, from a sensor, data indicative of a condition of the pasteurization process; comparing the data indicative of the condition of the pasteurization process to an expected value for the condition of the pasteurization process; and modifying, via an adjustment mechanism, operation of the pasteurization control device based on the comparison between the data indicative of the condition of the pasteurization process and the expected value for the condition of the pasteurization process.

12. The method of clause 11, further comprising inserting the sensor in a vessel that contains an article undergoing the pasteurization process.

13. The method of clauses 11 or 12, wherein the pasteurization control device is a spray head adapted to spray water over an article undergoing the pasteurization process; and wherein modifying operation of the pasteurization control device includes changing a temperature of the water sprayed over the article undergoing the pasteurization process.

14. The method of any of clauses 11-13, wherein the pasteurization control device is a conveyor belt adapted to transport a vessel that contains an article undergoing the pasteurization process; and wherein modifying operation of the pasteurization control device includes changing a speed of the conveyor belt.

15. The method of any of clauses 11-14, further comprising transmitting, via a wireless communication circuit included in the sensor, the data indicative of the condition of the pasteurization process.

16. The method of any of clauses 11-15, further comprising activating a visual indicator or an auditory alarm based on the comparison between the data indicative of the condition of the pasteurization process and the expected value for the condition of the pasteurization process.

17. In some embodiments, a pasteurization control system comprising a sensor adapted to sense a temperature of a pasteurization article contained in a vessel; a nozzle adapted to spray heated water over the vessel that contains the pasteurization article; an adjustment mechanism adapted to change a temperature of the heated water sprayed by the nozzle; and a controller coupled to the sensor and the adjustment mechanism, wherein the controller is adapted to control, via the adjustment mechanism, a temperature of the heated water sprayed by the nozzle in accordance with a baseline setting, receive, from the sensor, data indicative of the temperature of the pasteurization article, compare the temperature of the pasteurization article to an expected temperature value, and increase, via the adjustment mechanism, the temperature of the heated water sprayed by the nozzle when the temperature of the pasteurization article is less than the expected temperature value by at least a threshold amount.

18. The system of clause 17, wherein the sensor is disposed within the vessel that contains the pasteurization article.

19. The system of clauses 17 or 18, further comprising a conveyor belt adapted to transport the vessel the contains the pasteurization article; and wherein the controller is further adapted to decrease the speed of the conveyor belt when the temperature of the pasteurization article is less than the expected temperature value by at least a threshold amount.

20. The system of any of clauses 17-19, wherein the sensor includes a rechargeable battery that provides operational power to the sensor.

21. In some embodiments, a pasteurization sensor assembly comprising a housing;
an elongated probe that extends outward from the housing; a first temperature sensor disposed at a first position along the probe; a second temperature sensor disposed at a second position along the probe; a pressure sensor disposed at an end of the probe; and a wireless communication circuit contained within the housing, the wireless communication circuit adapted to transmit data generated by the first temperature sensor, the second temperature sensor, and the pressure sensor to a remote control device.

22. The pasteurization sensor assembly of cluse 21, further comprising a processor adapted to determine a temperature gradient within a pasteurization article based on data generated by the first temperature sensor and the second temperature sensor.

23. The pasteurization sensor assembly of clauses 21 or 22, further comprising a processor adapted to determine a cold spot within a pasteurization article based on data generated by the first temperature sensor and the second temperature sensor.

24. The pasteurization sensor assembly of any of clauses 21-23, further comprising a third temperature sensor supported on the housing.

25. The pasteurization sensor assembly of any of clauses 21-24, further comprising a metal cap that at least partially covers the housing.

26. The pasteurization sensor assembly of any of clauses 21-25, wherein the metal cap is in thermal contact with the third temperature sensor.

27. The pasteurization sensor assembly of any of clauses 21-26, wherein the housing is constructed from a plastic material; and wherein the probe includes a metal housing that surrounds the first, second, and third temperature sensors.

28. In some embodiments, a pasteurization sensor assembly comprising a housing including a control circuit contained within the housing and an elongated probe that extends outward from the housing. The probe includes a first temperature sensor disposed at a first position along the probe; a second temperature sensor disposed at a second position along the probe; a third temperature sensor disposed at a third position along the probe; a printed circuit board (PCB) that extends through an interior of the probe, wherein the PCB couples the first, second, and third temperature sensors to the control circuit; a thermal insulator that surrounds the PCB and the first, second, and third temperature sensors; and a metal tube that surrounds the thermal insulator, the PCB, and the first, second, and third temperature sensors.

29. The pasteurization sensor assembly of clause 29, wherein the control circuit is adapted to determine at least one of a temperature gradient or a cold spot within a pasteurization article based on data generated by the first, second, and third temperature sensors.

30. The pasteurization sensor assembly of clauses 28 or 29, wherein the probe further includes a pressure sensor disposed at an end of the probe.

31. The pasteurization sensor assembly of any of clauses 28-30, wherein the probe is coupled to the control circuit via the PCB.

32. The pasteurization sensor assembly of any of clauses 28-31, wherein the end of the probe comprises a hole adjacent the pressure sensor.

33. The pasteurization sensor assembly of any of clauses 28-32, further comprising a rechargeable battery that is at least partially disposed within the housing.

34. The pasteurization sensor assembly of any of clauses 28-33, further comprising electrical contacts for charging the rechargeable battery, wherein the electrical contacts are accessible via the housing.

35. The pasteurization sensor assembly of any of clauses 28-34, further comprising an antenna adapted to transmit data generated by the first, second, and third temperatures via a low-frequency wireless connection.

36. The pasteurization sensor assembly of any of clauses 28-35, further comprising an antenna adapted to transmit data generated by the first, second, and third temperatures via a low-frequency wireless connection.

37. The pasteurization sensor assembly of any of clauses 28-36, further comprising a metal spring contact that thermally couples the first temperature sensor to an interior surface of the metal tube.

38. In some embodiments, a pasteurization control system comprising a nozzle adapted to spray heated water over a vessel that contains a pasteurization article and a sensor assembly including an elongated probe shaped for insertion into the vessel that contains the pasteurization article, a first temperature sensor disposed at a first position along the probe, the first temperature sensor adapted to generate data indicative of temperature at a first depth within the vessel, a second temperature sensor disposed at a second position along the probe, the second temperature sensor adapted to generate data indicative of temperature at a second depth within the vessel, and a wireless communication circuit adapted to wirelessly transmit data generated by the first temperature sensor and the second temperature sensor. The system further comprising a control unit adapted to receive, from the wireless communication circuit, the data generated by the first temperature sensor and the second temperature sensor, and adjust a temperature of the heated water sprayed by the nozzle based on the data generated by the first temperature sensor and the second temperature sensor.

39. The pasteurization control system of clause 38, further comprising an insertion mechanism adapted to pierce a surface of the vessel contains the pasteurization article.

40. The pasteurization control system of clauses 38 or 39, wherein the sensor assembly is inserted in the vessel that contains the pasteurization article via a gland included in the insertion mechanism.

41. In some embodiments, a pasteurization system comprising a sensor module that includes a processor, a wireless communication circuit coupled to the processor, and a battery adapted to provide power to the processor and the wireless communication circuit; a nozzle adapted to spray heated water; a first sensor connected to the processor, the first sensor adapted to generate data indicative of a temperature of the heated water; a second sensor connected to the processor, the second sensor adapted to generate data indicative of a temperature of an article undergoing a pasteurization process; and a base plate that supports the sensor module, the nozzle, the first sensor, and the second sensor.

42. The pasteurization system of clause 41, wherein the control circuit is adapted to adjust the temperature of the heated water sprayed by the nozzle based on at least one of the data indicative of the temperature of the article undergoing a pasteurization process or the temperature of the data indicative of the temperature of the heated water.

43. The pasteurization system of clauses 41 or 42, further comprising a piercing mechanism that protrudes vertically upward from the base plate.

44. The pasteurization system of any of clauses 41-43, wherein the second sensor is disposed within an interior of the piercing mechanism.

45. The pasteurization system of any of clauses 41-44, wherein the second sensor is in thermal contact with the piercing mechanism.

46. The pasteurization system of any of clauses 41-45, further comprising a bus interface that electrically couples the first sensor and the second sensor to the control circuit.

47. The pasteurization system of any of clauses 41-46, wherein the bus interface includes a conductor that extends through an interior of the base plate.

48. The pasteurization system of any of clauses 41-47, wherein the first sensor is disposed within the sensor module.

49. The pasteurization system of any of clauses 41-48, wherein the first sensor is supported on the nozzle.

50. The pasteurization system of any of clauses 41-49, wherein the base plate comprises a first layer constructed from plastic and a second layer constructed from stainless steel.

51. The pasteurization system of any of clauses 41-50, further comprising first and second handles that extend outward from opposing sides of the base plate.

52. The pasteurization system of any of clauses 41-51, wherein the base plate is a machined plastic sled.

53. In some embodiments, a pasteurization system comprising a sensor module that includes a processor and a power supply adapted to provide power to the processor; a nozzle adapted to spray heated water over a vessel that contains an article undergoing a pasteurization process; a piercing mechanism adapted to pierce a hole in a surface of the vessel; a support structure adapted to clamp the vessel onto the piercing mechanism; and a sensor coupled to the processor, wherein the sensor is disposed within the piercing mechanism and adapted to generate data indicative of a temperature of the article contained in the vessel.

54. The pasteurization system of clause 53, further comprising a nozzle adapted to spray heated water over the vessel that contains the pasteurization article.

55. The pasteurization system of clauses 53 or 54, wherein the processor is adapted to adjust a temperature of the heated water sprayed based on the data indicative of the temperature of the article contained in the vessel.

56. The pasteurization system of any of clauses 53-55, wherein the sensor is a digital resistance temperature detector.

57. The pasteurization system of any of clauses 53-56, wherein the support structure includes compression clamps adapted to press a plate downward onto a top surface of the vessel.

58. The pasteurization system of any of clauses 53-57, wherein the piercing mechanism includes a needle.

59. The pasteurization system of any of clauses 53-58, wherein the piercing mechanism includes a carbon dioxide piercing element.

60. The pasteurization system of any of clauses 53-59, wherein the sensor is supported on a printed circuit board disposed underneath the piercing mechanism.

Although certain aspects have been described with reference to certain examples, variations and modifications exist within the spirit and scope of one or more independent aspects. Various features and aspects are set forth in the following claims.

Any and all combinations of any of the claim elements recited in any of the claims and/or any elements described in this application, in any fashion, fall within the contemplated scope of the present disclosure and protection. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine.

The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A pasteurization control system comprising:
an adjustment mechanism adapted to adjust a pasteurization parameter;
a sensor adapted to sense a pasteurization condition; and
a controller coupled to the adjustment mechanism and the sensor, wherein the controller is adapted to:
initiate a pasteurization process in accordance with a baseline setting for the pasteurization parameter;
receive data indicative of the pasteurization condition from the sensor; and
modify, via the adjustment mechanism, the pasteurization parameter based on a comparison between the data indicative of the pasteurization condition and an expected value for the pasteurization condition.

2. The system of claim 1, wherein the sensor is a temperature sensor;
wherein the pasteurization condition is a temperature of an article undergoing the pasteurization process; and
wherein the sensor is disposed within a vessel that contains the article undergoing the pasteurization process.

3. The system of claim 2, further comprising a spray head adapted to spray water over the article undergoing the pasteurization process; and
wherein the pasteurization parameter is a temperature of the water sprayed over the article undergoing the pasteurization process.

4. The system of claim 3, wherein to modify the pasteurization parameter based on the comparison, the controller is adapted to increase the temperature of the water sprayed over the article undergoing the pasteurization process when the temperature of the article undergoing the pasteurization process is less than the expected value by a threshold amount.

5. The system of claim 3, wherein to modify the pasteurization parameter based on the comparison, the controller is adapted to decrease the temperature of the water sprayed over the article undergoing the pasteurization process when the temperature of the article undergoing the pasteurization process is greater than the expected value by a threshold amount.

6. The system of claim 2, further comprising a conveyor belt adapted to transport a vessel that contains the article undergoing the pasteurization process; and
wherein the pasteurization parameter is a speed of the conveyor belt.

7. The system of claim 6, wherein to modify the pasteurization parameter based on the comparison, the controller is adapted to decrease the speed of the conveyor belt when the temperature of the article undergoing the pasteurization process is less than the expected value by a threshold amount.

8. The system of claim 6, wherein to modify the pasteurization parameter based on the comparison, the controller is adapted to increase the speed of the when the temperature of the article undergoing the pasteurization process is greater than the expected value by a threshold amount.

9. The system of claim 1, wherein the controller is connected to the sensor via a wireless connection.

10. The system of claim 1, wherein the sensor is disposed within a vessel that contains an article undergoing the pasteurization process.

11. A method for controlling a pasteurization process, the method comprising:
operating a pasteurization control device in accordance with a baseline setting;
receiving, from a sensor, data indicative of a condition of the pasteurization process;
comparing the data indicative of the condition of the pasteurization process to an expected value for the condition of the pasteurization process; and
modifying, via an adjustment mechanism, operation of the pasteurization control device based on the comparison between the data indicative of the condition of the pasteurization process and the expected value for the condition of the pasteurization process.

12. The method of claim 11, further comprising inserting the sensor in a vessel that contains an article undergoing the pasteurization process.

13. The method of claim 11, wherein the pasteurization control device is a spray head adapted to spray water over an article undergoing the pasteurization process; and
wherein modifying operation of the pasteurization control device includes changing a temperature of the water sprayed over the article undergoing the pasteurization process.

14. The method of claim 11, wherein the pasteurization control device is a conveyor belt adapted to transport a vessel that contains an article undergoing the pasteurization process; and
wherein modifying operation of the pasteurization control device includes changing a speed of the conveyor belt.

15. The method of claim 11, further comprising transmitting, via a wireless communication circuit included in the sensor, the data indicative of the condition of the pasteurization process.

16. The method of claim 11, further comprising activating a visual indicator or an auditory alarm based on the comparison between the data indicative of the condition of the pasteurization process and the expected value for the condition of the pasteurization process.

17. A pasteurization control system comprising:
a sensor adapted to sense a temperature of a pasteurization article contained in a vessel;
a nozzle adapted to spray heated water over the vessel that contains the pasteurization article;
an adjustment mechanism adapted to change a temperature of the heated water sprayed by the nozzle; and
a controller coupled to the sensor and the adjustment mechanism, wherein the controller is adapted to:
control, via the adjustment mechanism, a temperature of the heated water sprayed by the nozzle in accordance with a baseline setting;
receive, from the sensor, data indicative of the temperature of the pasteurization article;
compare the temperature of the pasteurization article to an expected temperature value; and
increase, via the adjustment mechanism, the temperature of the heated water sprayed by the nozzle when the temperature of the pasteurization article is less than the expected temperature value by at least a threshold amount.

18. The system of claim 17, wherein the sensor is disposed within the vessel that contains the pasteurization article.

19. The system of claim 17, further comprising a conveyor belt adapted to transport the vessel the contains the pasteurization article; and
wherein the controller is further adapted to decrease the speed of the conveyor belt when the temperature of the pasteurization article is less than the expected temperature value by at least a threshold amount.

20. The system of claim 17, wherein the sensor includes a rechargeable battery that provides operational power to the sensor.

21. A pasteurization sensor assembly comprising:
a housing;
an elongated probe that extends outward from the housing;
a first temperature sensor disposed at a first position along the probe;
a second temperature sensor disposed at a second position along the probe;
a pressure sensor disposed at an end of the probe; and
a wireless communication circuit contained within the housing, the wireless communication circuit adapted to transmit data generated by the first temperature sensor, the second temperature sensor, and the pressure sensor to a remote control device.

22. The pasteurization sensor assembly of claim 21, further comprising a processor adapted to determine a temperature gradient within a pasteurization article based on data generated by the first temperature sensor and the second temperature sensor.

23. The pasteurization sensor assembly of claim 21, further comprising a processor adapted to determine a cold spot within a pasteurization article based on data generated by the first temperature sensor and the second temperature sensor.

24. The pasteurization sensor assembly of claim 21, further comprising a third temperature sensor supported on the housing.

25. The pasteurization sensor assembly of claim 24, further comprising a metal cap that at least partially covers the housing.

26. The pasteurization sensor assembly of claim 25, wherein the metal cap is in thermal contact with the third temperature sensor.

27. The pasteurization sensor assembly of claim 21, wherein the housing is constructed from a plastic material; and
wherein the probe includes a metal housing that surrounds the first, second, and third temperature sensors.

28. A pasteurization sensor assembly comprising:
a housing including;
a control circuit contained within the housing; and
an elongated probe that extends outward from the housing, the probe including:
a first temperature sensor disposed at a first position along the probe;
a second temperature sensor disposed at a second position along the probe;
a third temperature sensor disposed at a third position along the probe;
a printed circuit board (PCB) that extends through an interior of the probe, wherein the PCB couples the first, second, and third temperature sensors to the control circuit;
a thermal insulator that surrounds the PCB and the first, second, and third temperature sensors; and
a metal tube that surrounds the thermal insulator, the PCB, and the first, second, and third temperature sensors.

29. The pasteurization sensor assembly of claim 28, wherein the control circuit is adapted to determine at least one of a temperature gradient or a cold spot within a pasteurization article based on data generated by the first, second, and third temperature sensors.

30. The pasteurization sensor assembly of claim 28, wherein the probe further includes a pressure sensor disposed at an end of the probe.

31. The pasteurization sensor assembly of claim 30, wherein the probe is coupled to the control circuit via the PCB.

32. The pasteurization sensor assembly of claim 30, wherein the end of the probe comprises a hole adjacent the pressure sensor.

33. The pasteurization sensor assembly of claim 28, further comprising a rechargeable battery that is at least partially disposed within the housing.

34. The pasteurization sensor assembly of claim 33, further comprising electrical contacts for charging the rechargeable battery, wherein the electrical contacts are accessible via the housing.

35. The pasteurization sensor assembly of claim 28, further comprising an antenna adapted to transmit data generated by the first, second, and third temperatures via a low-frequency wireless connection.

36. The pasteurization sensor assembly of claim 28, further comprising an antenna adapted to transmit data generated by the first, second, and third temperatures via a low-frequency wireless connection.

37. The pasteurization sensor assembly of claim 28, further comprising a metal spring contact that thermally couples the first temperature sensor to an interior surface of the metal tube.

38. A pasteurization control system comprising:
a nozzle adapted to spray heated water over a vessel that contains a pasteurization article;
a sensor assembly including:
an elongated probe shaped for insertion into the vessel that contains the pasteurization article,
a first temperature sensor disposed at a first position along the probe, the first temperature sensor adapted to generate data indicative of temperature at a first depth within the vessel,
a second temperature sensor disposed at a second position along the probe, the second temperature sensor adapted to generate data indicative of temperature at a second depth within the vessel, and
a wireless communication circuit adapted to wirelessly transmit data generated by the first temperature sensor and the second temperature sensor; and
a control unit adapted to:
receive, from the wireless communication circuit, the data generated by the first temperature sensor and the second temperature sensor, and
adjust a temperature of the heated water sprayed by the nozzle based on the data generated by the first temperature sensor and the second temperature sensor.

39. The pasteurization control system of claim 38, further comprising an insertion mechanism adapted to pierce a surface of the vessel contains the pasteurization article.

40. The pasteurization control system of claim 39, wherein the sensor assembly is inserted in the vessel that contains the pasteurization article via a gland included in the insertion mechanism.

41. A pasteurization system comprising:
a sensor module that includes a processor, a wireless communication circuit coupled to the processor, and a battery adapted to provide power to the processor and the wireless communication circuit;
a nozzle adapted to spray heated water;
a first sensor connected to the processor, the first sensor adapted to generate data indicative of a temperature of the heated water;
a second sensor connected to the processor, the second sensor adapted to generate data indicative of a temperature of an article undergoing a pasteurization process; and
a base plate that supports the sensor module, the nozzle, the first sensor, and the second sensor.

42. The pasteurization system of claim 41, wherein the control circuit is adapted to adjust the temperature of the heated water sprayed by the nozzle based on at least one of the data indicative of the temperature of the article undergoing a pasteurization process or the temperature of the data indicative of the temperature of the heated water.

43. The pasteurization system of claim 41, further comprising a piercing mechanism that protrudes vertically upward from the base plate.

44. The pasteurization system of claim 43, wherein the second sensor is disposed within an interior of the piercing mechanism.

45. The pasteurization system of claim 43, wherein the second sensor is in thermal contact with the piercing mechanism.

46. The pasteurization system of claim 41, further comprising a bus interface that electrically couples the first sensor and the second sensor to the control circuit.

47. The pasteurization system of claim 46, wherein the bus interface includes a conductor that extends through an interior of the base plate.

48. The pasteurization system of claim 41, wherein the first sensor is disposed within the sensor module.

49. The pasteurization system of claim 41, wherein the first sensor is supported on the nozzle.

50. The pasteurization system of claim 41, wherein the base plate comprises a first layer constructed from plastic and a second layer constructed from stainless steel.

51. The pasteurization system of claim 41, further comprising first and second handles that extend outward from opposing sides of the base plate.

52. The pasteurization system of claim 41, wherein the base plate is a machined plastic sled.

53. A pasteurization system comprising:
a sensor module that includes a processor and a power supply adapted to provide power to the processor;
a nozzle adapted to spray heated water over a vessel that contains an article undergoing a pasteurization process;
a piercing mechanism adapted to pierce a hole in a surface of the vessel;
a support structure adapted to clamp the vessel onto the piercing mechanism; and
a sensor coupled to the processor, wherein the sensor is disposed within the piercing mechanism and adapted to generate data indicative of a temperature of the article contained in the vessel.

54. The pasteurization system of claim 53, further comprising a nozzle adapted to spray heated water over the vessel that contains the pasteurization article.

55. The pasteurization system of claim 54, wherein the processor is adapted to adjust a temperature of the heated water sprayed based on the data indicative of the temperature of the article contained in the vessel.

56. The pasteurization system of claim 53, wherein the sensor is a digital resistance temperature detector.

57. The pasteurization system of claim 53, wherein the support structure includes compression clamps adapted to press a plate downward onto a top surface of the vessel.

58. The pasteurization system of claim 53, wherein the piercing mechanism includes a needle.

59. The pasteurization system of claim 53, wherein the piercing mechanism includes a carbon dioxide piercing element.

60. The pasteurization system of claim 53, wherein the sensor is supported on a printed circuit board disposed underneath the piercing mechanism.
